(19) United States
(12) Patent Application Publication
(10) Pub. No.: US 2026/0308877 A1
(43) Pub. Date: Oct. 8, 2026

(54) METHOD FOR OPERATING A SYSTEM FOR PERFORMING A WORK TASK OF A SELF-PROPELLED CONSTRUCTION MACHINE FROM A CONTROL STATION LOCATED REMOTELY FROM THE CONSTRUCTION MACHINE, AND A SYSTEM FOR PERFORMING A WORK TASK OF AT LEAST ONE SELF-PROPELLED CONSTRUCTION MACHINE FROM A CONTROL STATION LOCATED REMOTELY FROM THE CONSTRUCTION MACHINE

(71) Applicant: BOMAG GMBH, Boppard (DE)

(72) Inventors: Stephan HAMMES, Boppard (DE); Lukas MEBUS, Boppard (DE)

(21) Appl. No.: 19/548,073

(22) Filed: Feb. 24, 2026

(30) Foreign Application Priority Data
Feb. 26, 2025 (DE) 10 2025 107 182.9

(51) Int. Cl. E02F 9/20

(52) U.S. Cl. CPC E02F 9/205; E02F 9/2054

(57) ABSTRACT

A method for operating a system for performing a work task of a self-propelled construction machine from a control station located remotely from the construction machine, and to a system for performing a work task of at least one self-propelled construction machine from a control station located remotely from the construction machine, wherein the control station and the construction machine can communicate with each other via a control mode transmission connection and a monitoring mode transmission connection.

### FIELD

The invention relates to a method for operating a system for performing a work task of a self-propelled construction machine from a control station located remotely from the construction machine, and to a system for performing a work task of at least one self-propelled construction machine from a control station located remotely from the construction machine.

### BACKGROUND

The operation of self-propelled vehicles, in particular automated and especially semi-autonomous or autonomous vehicles, is constantly increasing and may also be of interest for the operation of one or more self-propelled construction machines. A system for integrating work assignments with a control station and several construction machines is disclosed in DE 10 2020 132 691 A1.

However, despite the aim of at least highly automated, in particular semi-autonomous or fully autonomous, operation of such self-propelled construction machines, there is a desire to still to have their operation monitored by a person, often also by a person located away from the construction machine within a control station. This requires suitable data communication connections. Furthermore, safety-critical incidents in the operation of such, especially autonomous, self-propelled construction machines and their handling continue to pose a challenge. Also, the operation of high-performance data communication connections for exchanging data between, for example, one or more of these construction machines with, for example, a control station, is often associated with comparatively high costs, as these data communication connections must regularly be reserved for a fee and/or their use must be paid for with the respective providers depending on the period of use and the volume of data transmitted. These challenges can become particularly serious if several, especially autonomous, self-propelled construction machines are to be monitored simultaneously and jointly by one person, for example from a control station.

### SUMMARY

Against this background, the object of the invention is to provide a way of improving the operation of a self-propelled construction machine.

The object is achieved with a method for operating a system for performing a work task of a self-propelled construction machine from a control station located remotely from the construction machine and with a system for performing a work task of at least one self-propelled construction machine from a control station located remotely from the construction machine according to the independent claims. Preferred embodiments are cited in the dependent claims.

A first aspect of the invention relates to a method for operating a system for performing a work task of a self-propelled construction machine from a control station located remotely from the construction machine.

The invention relates in particular to a construction machine which at least partially and in particular completely performs one or more work and/or travel tasks without permanent and/or continuous manual control intervention by an operator. Nevertheless, operation of the construction machine may be monitored by an operator or supervisor, for example at a control station, and in particular located remotely from the construction machine. Thus, even if the construction machine is an autonomously self-propelled construction machine, in the present sense this means in particular that the operation of the construction machine is monitored by an operator/supervisor, in particular one who is not traveling on the construction machine, in particular at or from a control station. Such a construction machine therefore travels and/or works in particular without manual control commands given directly to the construction machine locally by an operator. For this purpose, the construction machine may have a construction machine control unit, for example in the form of a suitable computer device. The highly automated or, in the present sense, in particular also autonomous operation may be characterized not only by travel instructions, such as travel direction, travel speed and/or steering specifications, which are provided by the construction machine control unit, but may also extend to the operation of one or more working units of the construction machine, for which one or more suitable control commands are generated by the construction machine control unit. With recourse to the classification according to automation levels defined in the SAE J3016 standard, this may therefore relate in particular to construction machinery that fulfills the requirements of levels 3, 4 or 5 of this standard, wherein for all of these automation levels herein a monitoring of the operation of the respective construction machine is provided from a location separate from the construction machine, such as a control station with a teleoperation workstation. In particular, it is therefore also possible for the construction machine to carry out travel and work tasks fully autonomously while being monitored by an operator at least at intervals and, in the manner described in more detail below, it is possible for an operator to transmit control commands to the construction machine from the control station. The invention relates in particular to road and earth-moving machines, especially comprising ground milling machines, such as road milling machines, stabilizers and recyclers, asphalt pavers, feeders and ground compaction machines, such as single-drum rollers, tandem rollers, rubber-wheeled rollers and waste compactors. Examples of such road and earth-moving machinery are described in EP4074894A1 and DE102015015793A1, among others. In the present case, working units refer in particular to those devices of the respective road construction and earth-moving machines that are to perform one or more specific working functions that go beyond mere travel operation of the respective construction machine.

For example, ground compactors often comprise, in addition to travel units configured at least partially as roller drums, one or more vibration excitation devices that can be adjusted between a vibration excitation state and a passive state, in particular in the form of so-called imbalance exciters, which can be used for dynamic compaction work. Additionally or alternatively, a working unit of such ground compactors may also be a bulk material spreader, a sprinkling device and/or an edge cutter, each of which may be adjustable between an active state and a passive state and/or in their relative position to the rest of the construction machine.

Ground milling machines usually comprise a ground milling device adjustable between a milling mode and an inactive mode, in particular in the form of a milling drum, which rotates in milling mode and engages the underlying ground to be milled. The speed and/or cutting depth of such a milling device may be variable. Further working units of such ground milling machines may be one or more sprinkling devices, suction devices, dust separation devices, one or more bulk material conveying devices, dosing devices for one or more aggregates, etc., which may likewise be adjustable at least between an active state and a passive state.

Asphalt pavers may in particular comprise a screed as a working unit, which is adjustable in terms of its working width, lifting height and inclination. Furthermore, a transverse distribution device may be included, in particular in the form of screw conveyors, which may be adjustable in terms of its conveying operation and its lifting height relative to the ground surface. Further working units of such asphalt pavers as well as feeders may be one or more bulk material conveyors, in particular longitudinal conveyors, as well as adjustable material hopper walls. These may also be adjustable at least between an active state and a passive state.

Accordingly, the, in particular highly automated, in particular autonomous, operation of the construction machine may thus in particular also comprise operating instructions for one or more of the respective working units, in particular an adjustment and control of a relative position of a working unit relative to a reference structure, such as the underlying ground and/or a machine frame, an activation and/or deactivation of the respective working unit(s) and/or a control, in particular regulation, of the operation of one or more working units, for example with regard to an activation and deactivation, one or more operating parameters, such as a rotational speed, an actuating position, etc., for example.

Herein, a control station in particular does not refer to an operator platform on the respective construction machine and in particular also not to a hand-held remote control known per se, with which the construction machine can usually be operated remotely within sight of an operator. The control station refers to a unit, in particular one that is immobile during operation, with which at least remote monitoring of the self-propelled construction machine, in particular a highly automated or autonomous one, is possible. Such a control station may therefore also be located remotely, for example up to several hundred kilometers or more away from the respective construction machine. During operation of the construction machine, the control station is usually manned by a supervisor who primarily monitors the operation of the construction machine, in particular highly automated, especially autonomous operation. The control station can thus enable at least partially teleoperated operation of the construction machine. Herein, direct and/or indirect teleoperation may be performed in particular when operation takes place in control mode.

According to the invention, operation of the construction machine and the control station in a monitoring mode is provided in a step or system state a) of the system. The monitoring mode refers in particular to an operating mode in which the construction machine is operated in a highly automated manner, in particular at least partially and in particular completely autonomously, i.e., in particular travel and/or operating specifications, as indicated above for example, are carried out by the construction machine control unit and the control station essentially only serves to monitor the operation of the construction machine. The monitoring mode thus refers to a normal operating mode, which is assumed in particular when the construction machine is operated as desired and intended, especially during a work task.

Accordingly, the monitoring mode may comprise acquiring status data relating to the construction machine on the construction machine using a sensor device. The sensor device may comprise a variety of suitable sensors for this purpose, as described in more detail below. The status data may, for example, relate to movement data of the construction machine, such as a direction of travel, a travel speed, one or more steering angles, acceleration data, a position and/or change in position of the construction machine relative to the ground and/or terrain, etc. Additionally or alternatively, further internal status data of the construction machine may also be acquired, such as the activation and/or deactivation state of one or more devices, such as motors, valves, actuators, pumps, etc., actuating positions and/or changes in the actuating position of one or more adjustable devices, such as actuators, in particular hydraulic cylinders and/or alternative actuators, one or more charge and/or fill levels, torques, pressures, etc., among other things. Additionally or alternatively, one or more external status data of the construction machine may also be acquired by the sensor device, such as the profile of a ground surface located in front of and/or next to and/or behind the construction machine, the external environment of the construction machine, current climatic conditions, obstacles, distances to elements external to the construction machine, in particular obstacles, etc. This status data may, for example, be determined discontinuously or continuously during operation of the construction machine using distance sensors, cameras, in particular video cameras, LIDAR sensors, ultrasonic sensors, force measurement sensors, displacement sensors, acceleration sensors, fill level and/or state of charge sensors, limit sensors, in particular also with the integration of suitable evaluation computer programs, such as image processing software and/or operation monitoring software.

Based on the acquiring of status data relating to the construction machine on the construction machine, the monitoring mode may also comprise transmitting the acquired status data from the construction machine to the control station via a monitoring mode transmission connection. The monitoring mode transmission connection thus refers to a communication connection via which, in particular, status data and/or data correlating therewith can be transmitted from the construction machine to the remote control station. Where the following description refers to the transmission of status data, this also includes a supplementary or alternative transmission of data correlating with the status data. Not all of the status data acquired on the construction machine needs to be transmitted permanently, but possibly only a subset of it and/or only periodically or at certain intervals. What is important is that the transmitted status data allows sufficient monitoring of the operation of the construction machine at the control station with sufficient certainty. The scope of the specific status data to be transmitted from the construction machine to the control station may therefore also vary depending, for example, on the type of construction machine, the total number of construction machines monitored at the control station, the specific work task and/or environment of the construction machine, the current climatic conditions at the construction machine’s location, etc. For example, position and/or position change data may be transmitted to monitor the movements of the construction machine, in particular periodically, while additional status data relating to the position or a position change of the construction machine, such as steering angle, direction of travel and/or travel speed data, even though also detected by the sensor device of the construction machine, may not be transmitted as part of the monitoring mode. The same may apply additionally or alternatively to one or more of the working units. For example, it is possible that only a distinction between an activated and a deactivated operating state of one or more working units is transmitted, while further operating details, such as current rotational speeds, displacement travel ranges, pressures, charges, force loads, etc., even though also detected by the sensor device of the construction machine, are not transmitted to the control station for monitoring purposes. Additionally or alternatively, it is also possible that internal monitoring steps are carried out, in particular by the construction machine control unit, during operation of the construction machine in order to monitor the intended operation of the construction machine. Such steps may be, for example, checking compliance with defined thresholds, a comparison with operating specifications of a work task, etc. However, the status data required for such checks does not necessarily need to be transmitted to the control station during operation of the construction machine, or may be transmitted only comparatively rarely. In particular, it is thus possible that only a subset of the status data acquired by the sensor device of the construction machine during operation is transmitted to the control station, and preferably not continuously, but at defined intervals, so that the total volume of data to be transmitted to the control station in monitoring mode or the amount of data to be transmitted per unit of time can be kept comparatively small. Status data may also be identification data of the respective construction machine, such as a serial and/or version number or other identification number and/or service-relevant data, such as operating hours, one or more fill levels, software versions, etc.

The transmission of status data from the construction machine to the control station may take place in particular via the monitoring mode transmission connection, especially in monitoring mode. This connection refers to the transmission path of the respective status data between the construction machine, specifically a signal output at the construction machine, for example in the form of a suitable transmitting antenna, and the control station, specifically a signal input at the control station, for example in the form of a suitable receiving antenna, for example Wi-Fi, 4G, 5G antennas or other suitable antennas. The transmission of the status data thus comprises, in particular, sending the status data from the construction machine using a suitable sending device comprising the signal output, forwarding the status data via the monitoring mode transmission connection and receiving the status data at the control station using a suitable receiving device comprising the signal input. The transmission path comprised in the monitoring mode transmission connection between this signal output and the signal input does not need to be homogeneous and uniform, but may also comprise several stages or sections, for example starting from the signal output on the construction machine side to a local router, which transmits the corresponding status data via a wired connection, for example a fiber optic cable connection, possibly also via several adjoining sections, to the signal input at the control station.

The status data may preferably be transmitted unidirectionally, in particular exclusively, from the construction machine to the control station. The monitoring mode transmission connection may thus act as a kind of one-way street, so that the data volume to be transmitted in monitoring mode can also be kept comparatively low in this way, as the monitoring mode transmission connection in this case does not necessarily need to have a return channel for transmitting data from the control station to the construction machine.

In addition to operation in monitoring mode, the method according to the invention also comprises operation of the construction machine and the control station, in particular the system for performing a work task of a, in particular highly automated, especially autonomous, self-propelled construction machine from a control station located remotely from the construction machine, in a control mode according to a step or operating state b).

Here too, status data relating to the construction machine is acquired at the construction machine using the sensor device. Reference is therefore also made at this point to the previous discussion of the possible acquisition of status data relating to the construction machine. It should also be noted that the status data acquired in monitoring mode and control mode may be identical, but does not have to be. In particular, it is possible that in control mode at least partially other and/or more and/or more detailed status data is acquired compared to monitoring mode in order to obtain a more comprehensive and/or more precise picture of the current status of the construction machine.

The control mode also comprises transmitting the acquired status data from the construction machine to the control station, but then at least partially, and in particular exclusively, via a control mode transmission connection. In particular, this may include sending status data from the construction machine and receiving the sent status data at the control station. However, it is now possible to change the transmission path at least partially from the monitoring mode to the control mode, specifically from the monitoring mode transmission connection to the control mode transmission connection. The control mode transmission connection also refers to a transmission path, for example of the respective status data between the construction machine, specifically a signal output, for example a suitable transmitting antenna, at the construction machine, and the control station, specifically a signal input, for example a suitable receiving antenna, at the control station. This may involve the same signal inputs and outputs as the monitoring mode, in particular, for example, the same antennas ("multi-tasking"), or separate ones. The antennas may be Wifi, 4G, 5G antennas or other suitable antennas, for example. The transmission of the status data in control mode may thus also comprise, in particular, sending the status data from the construction machine using a suitable sending device comprising the signal output, forwarding the status data via the control mode transmission connection and receiving the status data at the control station using a suitable receiving device comprising the signal input. The transmission path between this signal output and the signal input comprised in the monitoring mode transmission connection also does not need to be homogeneous and uniform, but may also comprise several stages or sections. For example, in addition to wired transmission sections, such as via an underground cable, it may also comprise wireless transmission sections, for example as part of one or more local networks and/or between antennas and/or a satellite-based transmission path. Switching between the two transmission connections may take place automatically, for example when one or more predefined operating events occur or when operating and/or status parameters of the construction machine change. However, it may also be possible for the switchover or at least the activation of the control mode transmission connection to be initiated manually by an operator, in particular at the control station. This may be useful, for example, for service purposes and/or remote diagnostics or the like.

Additionally or alternatively, however, it is also possible for the control mode transmission connection to enable data to be sent from the control station to the construction machine. This means, for example, that control commands can be transmitted from the control station to the construction machine via the control mode transmission connection. Compared to the monitoring mode transmission connection, the control mode transmission connection may be configured in particular for a bidirectional exchange of data between the construction machine and the control station. This means that in control mode, status data can be transmitted from the construction machine to the control station via the control mode transmission connection and, conversely, data, in particular control data, can be transmitted from the control station to the construction machine. The transmission of the status data in monitoring mode via the monitoring mode transmission connection may thus preferably, in particular exclusively, be unidirectional from the construction machine to the control station. In control mode, it may be preferred that the communication between the construction machine and the control station is bidirectional between the construction machine and the control station via the control mode transmission connection, but at least control data can be transmitted from the control station to the construction machine via the control mode transmission connection.

The control mode may thus also comprise generating control data or control commands at the control station, in particular manually. Specifically, this may therefore mean that the control station comprises a user interface via which an operator can enter control commands at the control station which can then be transmitted, in particular in the form of control data, from the control station to the construction machine via the control mode transmission connection. In control mode, the operator can therefore influence the operation and/or operating status of the construction machine from the control station via the control mode transmission connection and, in particular, not only monitor the operation of the construction machine, as in monitoring mode. For this purpose, the control station may comprise a suitable control station control unit, in particular comprising one or more computer devices with one or more suitable computer programs.

The control mode therefore also comprises, in particular, transmitting control data from the control station to the construction machine via the control mode transmission connection. Specifically, this may comprise sending the control data via a signal output at the control station and receiving the control data at a signal input at the at least one construction machine. Again, this may involve one or more suitable antennas. It is thus possible that both the control station and the at least one construction machine each comprise respective sending and receiving devices configured at least for exchanging data between the control station and the construction machine via the control mode transmission connection. The respective sending and receiving devices may be configured to enable communication both via the monitoring mode transmission connection and via the control mode transmission connection. Alternatively, it is possible that the control station and/or the construction machine each comprise respective sending and receiving devices for communication on the one hand only via the monitoring mode transmission connection and on the other hand only via the control mode transmission connection.

In control mode, it is further possible that the control data received by the at least one construction machine via the control mode transmission connection is executed, i.e., the corresponding control commands are implemented, on/at/by the construction machine. This may be controlled via the construction machine control unit at the construction machine. Possible control commands may be, for example, travel and/or steering commands, activation and/or deactivation commands for one or more functional devices of the construction machine, activation and/or deactivation commands for parts of the sensor device, computer programs and/or parts thereof, in particular updates thereto, etc.

According to the invention, it is now possible that the control mode transmission connection has a lower latency and/or a higher data transmission rate and/or greater bandwidth than the monitoring mode transmission connection. This is to be understood in particular with regard to a maximum possible utilization of the respective transmission connection. Ideally, the latency of the control mode transmission connection should be not more than half the latency of the monitoring mode transmission connection, ideally not more than a tenth of the latency of the monitoring mode transmission connection. Additionally or alternatively, it may be advantageous if the data transmission rate of the control mode transmission connection, in particular the maximum available data transmission rate, is at least twice as high as the maximum available data transmission rate of the monitoring mode transmission connection, in particular even at least by a factor of 10 higher.

Herein, the latency of the transmission connection refers in particular to the delay time when transmitting the data (status data and/or control data) between the respective sending end, for example the construction machine in monitoring mode, and the receiving end, for example the control station in monitoring mode. The relevant latency or latency time herein does not extend in particular to transmission and/or processing times within the control station and/or within the construction machine, but to the latency of the transmission path between these two elements. The latency of the transmission connection may be indicated in a unit of time, for example seconds. In particular, it may depend on the type of transmission connection and/or the distance between the sending end and the receiving end or the length of the transmission connection and/or a current network load. To determine the latency of a data transmission path, it is possible, for example, to provide one or more data packets to be transmitted with a time stamp and in this way determine the time difference between sending and receiving the respective data packet.

Herein, the data transmission rate refers in particular to the speed at which data can be transmitted between the receiving end and the sending end, for example in the present case between the at least one construction machine and the control station, i.e., via the respective transmission connection. The data transmission rate may be indicated, for example, in bits or bytes per second. To determine a current, and in particular a current maximum, data transmission rate, it is possible to transmit one or more data packets of a known size and, again using a time stamp, for example, to determine the time required for data transmission.

In this case, the bandwidth refers in particular to a maximum amount of data, in particular predetermined, that can be transmitted in a certain period of time. It refers to the capacity for transmitting data. It may be indicated in Hertz (Hz), for example. It may also be measured using an oscilloscope, for example.

This means that data is transmitted between the construction machine and the control station in monitoring mode via a data transmission connection that is less powerful in terms of latency and/or transmission rate than the data transmission connection in control mode. However, this reduced performance in terms of transmission speed may be acceptable in monitoring mode, because in this operating mode the construction machine preferably operates in a highly automated, in particular autonomous, and planned manner. This means that there is no need for, in particular practically immediate, transmission of control data for control commands to be implemented on the construction machine from the control station. In this case, it may therefore also be sufficient if it is only monitored at the control station with a comparatively long time delay that the at least one construction machine is currently being operated correctly. In this case, for example, it may be sufficient for monitoring purposes if only position data and/or status messages and/or intermittent images of the surroundings are transmitted from the construction machine to the control station at regular intervals. Such data transmission connections, which are suitable or can be used as a monitoring mode transmission connection with a relatively high latency and/or a relatively low data transmission rate and/or a relatively narrow bandwidth, can usually be used comparatively inexpensively.

In control mode, on the other hand, the situation may be different, as this mode may be assumed, for example, if the construction machine is not working properly, for example due to a fault within the machine, or cannot work properly, for example due to an unacceptable and/or unexpected event in the vicinity of the construction machine. In control mode, it may therefore also be desirable to have an image transmission, for example as a video feed, available in practically real time or as close as possible to a real time display at the control station, for example to enable reliable and situation-appropriate intervention by an operator via the control station. If the construction machine is at least partially operated from the control station or in teleoperated mode, it is advantageous if a more powerful data transmission connection is available in terms of latency and/or data transmission rate. Furthermore, additionally or alternatively, it is advantageous if bidirectional communication between the construction machine and the control station is enabled via the data transmission connection used, for example for transmitting status data of the construction machine to the control station and/or for transmitting control commands or control data from the control station to the construction machine, in particular with practically no time delay or with as little time delay as possible. Data transmission connections that can be used as a control mode transmission connection with a relatively low latency and/or a relatively high data transmission rate and/or a relatively high bandwidth enable a comparatively fast data exchange between the construction machine and the control station, so that, for example, a near real time transmission of a video feed and/or a relatively fast transmission of control commands etc. is possible in teleoperated mode or in control mode. In this case, even comparatively extensive data can ideally be exchanged between the construction machine and the control center with virtually no or very little time delay. However, such data transmission connections are often comparatively expensive and/or must be rented and/or reserved in advance. However, since the use of the control mode transmission connection in the present method is limited to the control mode that tends to occur in exceptional cases, which does not relate to the normal operational use of the construction machine, but rather to events that occur less frequently, such as a malfunction and/or an emergency situation and/or maintenance work, this is acceptable in the present case and is therefore a reasonable compromise from both an economic and operational point of view.

Sending and receiving data to/from the construction machine via the monitoring mode transmission connection and/or the control mode transmission connection may be carried out wirelessly in particular. Sending and receiving data transmitted via the monitoring mode transmission connection and/or the control mode transmission connection at the control station may be realized, for example, via an Ethernet connection, wirelessly, in particular via a dedicated antenna, a connection cable for satellite communication or the like. Additional computing units may also be provided for encrypting and/or decrypting data.

It is possible that during operation of the construction machine in monitoring mode, the control mode transmission connection is unused, i.e., no data, in particular control data and/or status data, is transmitted unidirectionally or bidirectionally between the construction machine and the control station via the control mode transmission connection. However, it is advantageous if the control mode transmission connection is kept available in monitoring mode. This may be done, for example, by reserving a control mode transmission connection or the like.

It is also possible that before starting a traveling and/or working operation and/or activating one or more, in particular mechanically operating, units of the construction machine, a check is carried out to determine whether a control mode transmission connection is at least available or not. This may be done, for example, by transferring a test data set via the control mode transmission connection from the construction machine to the control station and/or from the control station to the construction machine. This may be controlled by the construction machine control unit and/or the control station control unit. It is possible that the start of operation of the construction machine in monitoring mode is only possible if the availability of the control mode transmission connection has been checked beforehand, as described above.

Additionally or alternatively, it is also possible for an availability signal to be exchanged between the construction machine and the control station at regular intervals via the control mode transmission connection while the construction machine is operating in monitoring mode. An availability and/or integrity check of the control mode transmission connection may therefore also be provided during operation of the construction machine in monitoring mode. This may take place unidirectionally or bidirectionally between the construction machine and the control station and may be controlled and/or monitored by the construction machine control unit and/or the control station control unit. It is possible that if it is determined that the control mode transmission connection is currently not available at all, no longer available or at least not fully functional, the operation of the construction machine in monitoring mode is completely or at least partially stopped and/or reduced by the construction machine control unit and/or the control station control unit and/or at least an information message is issued to the operator at the control station and/or this is displayed on the construction machine.

It is possible that in step a), status data to be transmitted from the construction machine to the control station is compressed on the construction machine side and compressed status data received from the construction machine is decompressed on the control station side. For this purpose, the sending and/or receiving devices of the construction machine and/or the control station and/or the construction machine control unit and/or the control station control unit may comprise one or more suitable computer programs. In this way, the data volume to be transmitted in monitoring mode via the less powerful monitoring mode transmission connection can be further reduced, even if the availability of the status data at the control station can be further delayed by the two additional data processing steps required.

The monitoring mode and the status data transmitted from the construction machine to the control station in monitoring mode can be used in particular to assess, in the sense of supervision, whether the at least one construction machine is currently working properly and/or whether there are any malfunctions, in particular malfunctions that potentially require manual intervention in the operation of the construction machine by the operator located at the control station. This may be done during operation of the construction machine using defined criteria, for example using defined acceptable operating parameter intervals and/or thresholds etc., by the construction machine control unit and/or the control station control unit. One or more activation events may be defined for activation of the control mode transmission connection described above, and a check can be carried out by the construction machine control unit and/or the control station control unit and/or by the operator at the control station in monitoring mode as to whether or not an activation event has occurred based on the available status data. In step a) in monitoring mode, it is therefore possible to evaluate the status data to determine whether an activation event has occurred or not. If it is determined, for example by the construction machine control unit and/or the control station control unit and/or the operator, that an activation event has occurred, the control mode transmission connection for data transmission at least from the control station to the construction machine may be activated. Evaluating and/or checking for occurrence of an activation event may therefore be carried out on the construction machine side and/or the control station side. It is possible that, in particular in or by the construction machine control unit and/or the control station control unit, the occurrence of defined events and/or the occurrence of unexpected status data and/or certain operating events and/or situations, operating parameter ranges and/or the exceeding and/or falling below of one or more limit values etc. is checked. If occurrence of an activation event is detected, the control mode transmission connection may be activated by the construction machine or the construction machine control unit directly or via a corresponding signal transmitted via the monitoring mode transmission connection and/or from the control station or the control station control unit. The control mode transmission connection may therefore be activated automatically, for example, when an activation event occurs. Additionally or alternatively, it is also possible to initiate the control mode transmission connection manually. This can also be done at the control station and/or, if it is configured for this purpose, at the construction machine.

It is advantageous if the control station and/or the construction machine display whether the control mode transmission connection and/or the monitoring mode transmission connection is currently available and/or is being used for data transmission. This may be done by means of a suitable display device, for example using a display screen, at the control station and/or the construction machine.

With regard to the specific definition of one or more activation events, there are various preferred options. For example, it is possible that the control mode transmission connection is activated depending on a process-dependent and/or safety-dependent and/or service-dependent activation event. Process-dependent activation events may be situations in which the work process and/or the operating process of the construction machine does not work within one or more defined parameters. This may, for example, relate to an operating parameter of one or more working units and/or position and/or position change parameters and/or orientation parameters, for example a transverse and/or longitudinal inclination, travel operating parameters, etc. of the construction machine which deviate from a set value. In addition or as an alternative to these operating parameters, which tend to be external to the construction machine, internal operating parameters may also be used to check for process-dependent activation events. This may, for example, relate to fill levels of one or more operating fluids and/or a state of charge of an electrical energy storage device and/or rotational speeds, torques, adjustment speeds, etc. of one or more units of the construction machine. Combinations of several such parameters for checking the occurrence of an activation event are also conceivable and are covered by the invention, for example if slippage occurs at one or more of the travel units of the construction machine, etc. Safety-dependent activation events relate to events under which safe operation of the construction machine can no longer be guaranteed. This may relate to the functional integrity of individual or multiple components of the construction machine itself and/or the environment of the construction machine, for example if it is on a collision course with one or more obstacles and/or leaves a defined work area and/or safety-relevant events occur in the vicinity of the construction machine, for example if people are too close to the construction machine, etc. Service-dependent activation events may be events such as an identity check of one or more operators and/or the specification of a work plan and/or maintenance and/or repair events. In particular, this may mean and include active initiation of the control mode transmission connection by an operator at the control station. Finally, vandalism protection and/or vandalism prevention may also represent an activation event, especially if the construction machine is monitored in a stationary mode in monitoring mode or its surroundings are monitored and unauthorized activities at the construction machine are detected. When the control mode transmission connection is activated, it is then possible, for example, for unauthorized persons present at the construction machine to be informed and/or warned from the control station by the operator at the control station.

In principle, it is possible for the status data to be evaluated to determine whether an activation event has occurred on the construction machine and/or control station side using the construction machine control unit and/or the control station control unit. Ideally, for example, a check for process-dependent activation events is carried out at least with the aid of the construction machine control unit, a check for safety-dependent activation events is carried out by both the construction machine control unit and the control station control unit, and a check for service-dependent activation events is carried out by the control station control unit and/or the construction machine control unit. The status data used by the construction machine control unit and the control station control unit as the basis for the respective check may differ if both control units check for occurrence of an activation event in parallel. In particular, it may be preferred, for example, if the construction machine control unit essentially relies on status data of individual or several components and/or units of the construction machine and/or operating data of the construction machine and/or events in the working area and environment of the construction machine when checking for process-dependent activation events, and the control station control unit relies more on the position or position change data of the construction machine.

In monitoring mode, the construction machine is preferably operated in a highly automated, in particular autonomous, operating mode. This may mean that the construction machine control unit automatically generates and executes control commands, for example based on available status data and/or a work plan specification. During operation of the construction machine in control mode according to step b), on the other hand, it may be preferred if autonomous control commands generated on the construction machine side are at least partially and in particular completely suppressed or at least executed with lower priority than control data received from the control station via the control mode transmission connection. At this point, it is also possible to deactivate any autonomous functions of the construction machine and control it completely and exclusively via control commands transmitted from the control station to the construction machine. In the event that the construction machine or the construction machine control unit still generates autonomous, in particular at least partially autonomous or highly automated, or autonomous control commands even in control mode, it is advantageous if at least the construction machine control unit checks whether a control command currently generated by the construction machine control unit, in particular autonomously, conflicts with a current control command received from the control station. If this is the case, it is possible that the construction machine control unit then prioritizes the current control command received from the control station over the control command generated by itself, in particular autonomously, and/or suppresses or does not execute the control command generated by itself, in particular autonomously. Additionally or alternatively, it is possible that the control command, in particular the autonomous control command, is only allowed for execution by the construction machine control unit when there is no longer any conflict with a control command received from the control station.

It is possible that in step b) at least control data to be transmitted from the control station to the construction machine via the control mode transmission connection is encrypted on the control station side, in particular by the control station control unit, and encrypted control data received via the control mode transmission connection on the construction machine side, in particular by the construction machine control unit, is decrypted. Such encryption and decryption processes may be carried out using, for example, suitable certificate files or similar.

Additionally or alternatively, it is possible that in step b) an authorization and/or identity check and/or machine-specific assignment check is carried out on the construction machine side, in particular by the construction machine control unit. The authorization check may, for example, comprise a check as to whether the control station communicating with the construction machine is an authorized control station and/or an authorized operator or an authorized teleoperator at the control station. The authorization and/or identity check may relate to all control commands received from the control station or only to a subset of control commands. For example, it is possible that certain control commands relating to maintenance may only be transmitted from a specific control station and/or a specific operator at the control station and executed on the construction machine. The machine-specific assignment check, on the other hand, concerns a check to determine whether the control command received from the construction machine is a control command that can be executed by the construction machine according to its current configuration and/or specification. This may include, for example, a check as to whether control commands relating to optional and/or variable components and/or certain computer program versions of the respective construction machine can and/or should be executed at all in view of the current configuration of the construction machine.

Accordingly, it is possible that in step b) control data transmitted from the control station to the construction machine comprise a proof of authorization or that at least at the beginning of a communication via the control mode transmission connection and/or at the beginning of a reception of a new control command such a proof of authorization is transmitted from the control station, in particular via the control mode transmission connection. The information comprised in the proof of authorization may include a user identity and/or localization, a control station identity and/or localization, an authorization level and/or scope of authorization, a functional scope authorization, etc. These may be checked at the construction machine by the construction machine control unit.

It is advantageous if, at least in step b), the control data and/or status data transmitted via the control mode transmission connection are transmitted between the control station and the construction machine at least partially via a satellite-based data transmission connection. The use of such data transmission connections is generally comparatively expensive. However, such data transmission connections are often characterized not only by their practically global reach, but also by their comparatively low latency and their possible high transmission rates and/or possible large bandwidth compared to conventional data transmission connections for the present use for communication between the control station and the construction machine.

It is possible that during an existing activated control mode transmission connection in control mode, data, in particular at least part of the status data of the construction machine, is transmitted in parallel via the monitoring mode transmission connection. In this case, data is transmitted in parallel via both data transmission connections. In this case, it may be preferred for the communication or data transmission from the control station to the construction machine to take place exclusively via the control mode transmission connection. Furthermore, it is additionally or alternatively preferred if safety-relevant status data, in particular image and video data, are transmitted from the construction machine to the control station via the control mode transmission connection and the data transmitted via the monitoring mode transmission connection is limited to status data that is not directly safety-relevant and/or also allows delayed reactions from the control station. These may be, for example, fill level and/or charge level data of the construction machine, as these usually only change comparatively slowly. However, it is understood that the assignment of which type of status data is not considered directly safety-relevant may vary depending on the current usage scenario and/or the type of construction machine and/or the current activation event.

However, as an alternative to the previous embodiment of the method according to the invention, it is also possible that during operation of the construction machine in control mode according to step b), the monitoring mode transmission connection is completely switched off or deactivated or ignored and communication between the control station and the construction machine takes place exclusively via the more powerful control mode transmission connection.

On construction sites, especially road construction sites, more than one construction machine is often operated at the same time. In such an operating scenario, the advantages of the invention become particularly apparent, especially if more than one highly automated, in particular autonomous, self-propelled construction machine is operated at the same time. It is then preferred if, in the monitoring mode according to step a), a plurality of construction machines transmit status data to said one control station in parallel and, when the control mode is activated, one of the several construction machines, specifically in particular only the construction machine for which an activation event has occurred and been determined or which is affected by such an event, switches to the control mode according to step b) whereas the other ones of the plurality of construction machines continue to be operated in the monitoring mode according to step a). In this way, the control data transmission line may be used particularly efficiently for the particular construction machine affected by the activation event, and the other construction machines may continue to be operated in monitoring mode with communication taking place via the monitoring transmission line.

It is possible that when the control mode of said one of said plurality of construction machines is activated in accordance with step b), a status message is transmitted to the other ones of the plurality of construction machines. In particular, the status message may include the information that an activation event has occurred for this construction machine and/or that it is currently being operated in control mode. This status message may be transmitted via a direct communication connection between the individual construction machines, via a local communication network via which the individual construction machines communicate with each other, and/or via the monitoring mode transmission connection (which in this case is bidirectional) and/or via the control mode transmission connection. It is possible that those construction machines that continue to be operated in monitoring mode or for which the activation event has not occurred are operated, with regard to at least one operating parameter, to a limited extent in a protective operating mode compared to a normal operating mode after receipt of the respective status message. This may be controlled by the respective construction machine control unit of these construction machines. This restriction of scope may, for example, relate to the local definition of a permissible working and/or movement area of the construction machine and/or a maximum permissible travel speed and/or a maximum permissible working intensity of a working unit, such as a vibration exciter, etc. In this way, construction machines that move in the vicinity of a defective construction machine, in particular highly automated, especially autonomous, self-propelled machines, can be operated more safely. It is possible for this operating restriction to be canceled centrally by the control station and/or by individual construction machine control units, even if the particular construction machine affected by the activation event is still in control mode. Additionally or alternatively, it is also possible for the construction machine affected by the activation event to transmit an updated status message to the other construction machines in the manner described above once the cause of the activation event has been eliminated/remedied. This may trigger a return of multiple and in particular all construction machines to monitoring mode and/or normal operating mode.

When the control mode of one of the multiple construction machines is activated in accordance with step b), it is possible for other ones of the multiple construction machines to be stopped and/or switched off. This may be done by transmitting one or more control commands via the monitoring mode transmission connection and/or using the control mode transmission connection at least temporarily. This stopped and/or switched-off state may be maintained at least until the particular one of said plurality of construction machines has returned to monitoring mode and/or has reached a defined parking position, for example, and/or an active permission has been given via the control station. This information or a corresponding control command may likewise be transmitted by transmitting one or more control commands via the monitoring mode transmission connection and/or using the control mode transmission connection at least temporarily.

The possible effects of switching one of the construction machines to control mode on the other construction machines described above may vary depending on the current activation event. For example, the more serious the activation event of said construction machine is, the more comprehensive the effects on the operation of the other construction machines may be and vice versa. If, for example, there is an acute danger posed by the construction machine affected by the activation event, it may be advantageous to stop the operation of the other construction machines in a controlled manner. If, on the other hand, the activation event is rather a non-safety-relevant event, for example a marginal power drop, a low level of an operating fluid, etc., this may have no effect at all on the operation of the other construction machines. In order to assign the escalation levels of effect that an activation event of one of the construction machines has on the other construction machines, the construction machine control units and/or the control center control unit may comprise, for example, an activation event library in which such assignments are defined in advance. Additionally or alternatively, one or more AI algorithms and/or machine learning may also be used for this purpose.

Additionally or alternatively, it is also possible that, in the event that the control mode transmission connection in step b) and/or the monitoring mode transmission in step a) cannot be established by the particular construction machine of the plurality of construction machines, in particular if it is affected by an activation event, the particular construction machine establishes a signal transmission connection to one of the plurality of other construction machines and uses this as an intermediate link to establish the control mode transmission connection. In this case, the construction machine which acts as a data transmission intermediate link, stops working operation and/or approaches the construction machine affected by the activation event locally if it is also a highly automated, particularly autonomous, self-propelled construction machine.

A further aspect of the invention relates to a system for carrying out a work operation of at least one, in particular highly automated, especially autonomous, self-propelled construction machine from a control station located remotely from the construction machine. This system, i.e., the overall system comprising the at least one construction machine and the control station may be configured in particular for carrying out a method according to the invention.

The system comprises at least one, in particular highly automated, especially autonomous, self-propelled construction machine. Part of the construction machine is a sensor device for acquiring status data of the construction machine, in particular during operation of the construction machine. For this purpose, the sensor device may comprise one or more suitable sensors, as already described above in the discussion of the method according to the invention, to which reference is also made here in particular. The construction machine may further comprise a construction machine control unit to which the sensor device transmits the status data acquired by the at least one or more sensors, for example by means of one or more wired and/or wireless data transmission connections within the construction machine. The construction machine control unit may be configured to generate one or more, in particular autonomous, control commands for the construction machine.

The system also includes a control station located remotely from the construction machine for monitoring the operation of the at least one construction machine. In particular, the control station may be a teleoperation device or a teleoperation workstation with a teleoperator, especially a human operator. The teleoperation device may also be particularly suitable for the simultaneous monitoring of several, in particular highly automated, especially autonomous, self-propelled construction machines. The system according to the invention may thus also comprise several construction machines in addition to the particular control station. The control station may include a control station control unit, which is configured, for example, to transmit control commands entered manually at the control station to the at least one construction machine using a suitable communication device.

The system may comprise a monitoring mode transmission connection, via which status data of the construction machine acquired by the sensor device is transmitted to the control station during operation of the at least one construction machine. In this way, a teleoperator located remotely from the construction machine at the control station can check and monitor the current operation of the construction machine using the status data of the construction machine available at the control station, even if it is operated in a highly automated manner, particularly autonomously, and performs travel movements and/or work tasks independently. With regard to possible configuration details of the monitoring mode transmission connection, reference is also made in particular to the preceding details of the method according to the invention and these are referred to individually or in combination with one another. The monitoring mode transmission connection may thus primarily provide a means of monitoring or tracking the operation of the construction machine at least partially from the control station during normal operation of the construction machine, i.e., when it is operated in a monitoring mode, in particular as defined for methods according to the invention.

It is now possible that the device further comprises a control mode transmission connection. This connection may in particular be configured to transmit control data from the control station to the at least one construction machine. It may also be used to transmit monitoring data and/or status data from the construction machine to the control station. What is important is that the use of the control mode transmission connection may be limited to operation of the device in a control mode, in particular a control mode as defined for the method according to the invention. By switching the operation of the system from monitoring mode to control mode, a switchover from the monitoring mode transmission connection to the control mode transmission connection and/or at least an activation and communication via the control mode transmission connection in addition to the monitoring mode transmission connection may thus be provided.

In particular, the control mode transmission connection may be a data transmission connection that has a lower latency and/or a higher data transmission rate than the monitoring mode transmission connection. With regard to possible configuration details of the control mode transmission connection, reference is also made in particular to the preceding details of the method according to the invention and are referred to individually or in combination with one another.

Specifically, this may mean that the control mode transmission connection is configured, for example, such that its latency between a signal output/input at the control station and a signal input/output at the at least one construction machine is not more than 500 ms, in particular not more than 250 ms, especially not more than 50 ms and ideally not more than 10 ms.

The latency of the monitoring mode transmission connection, on the other hand, may be considerably greater. For example, it is advantageous if the latency of the monitoring transmission device is at least 1 s, in particular at least 2 s.

Additionally or alternatively, the control mode transmission connection may be configured such that its data transmission rate between a signal output/input at the control station and a signal input/output at the at least one construction machine is at least 1 Mbit/s, for example. The control mode transmission connection may therefore also be configured such that it has, for example, a data transmission rate of at least 50 Mbit/s, in particular at least 100 Mbit/s, since it may be a teleoperative data line. In the case of image or video transmission from the construction machine to the control station, it may be preferred if the data transmission rate is at least high enough to enable transmission of 30 frames per second (fps). Even though this obviously also depends on the number of image capturing units and/or the image capturing quality, this does not change the fact that a transmission rate for one and the same image capturing system of a maximum of 2 images per second is sufficient for the monitoring mode transmission connection, whereas the control mode transmission connection should have a transmission rate which, based on the same image capturing system, has a transmission rate with which a transmission of at least 30 images per second from the construction machine to the control station is possible.

For the monitoring mode transmission connection, on the other hand, it may be sufficient for the data transmission rate to be not more than 500 kbit/s, in particular 100 kbit/s, or even significantly less.

The bandwidth of the control mode transmission connection may usually be predefined by the system.

It is advantageous if the at least one construction machine has a construction machine control unit. This control unit may be a computer device with one or more computer programs, which in particular are also configured to carry out highly automated, especially autonomous, traveling and/or working functions of the construction machine. The construction machine control unit may also be configured to control the transmission of monitoring data in monitoring mode via the monitoring mode transmission connection.

It is also possible, additionally or alternatively, for the construction machine control unit to have one or more modules, in particular in the form of at least one or more computer programs. In the present case, a module refers in particular to a functional unit for performing one or more functions, in particular with the aid of one or more computer programs.

Such module may, for example, be a check module, which may be configured in particular to check during operation of the construction machine in monitoring mode or at least at the start of such operation whether a control mode transmission connection is available or not. This may be done, for example, by a test transmission of an availability signal via the control mode transmission connection and/or evaluation of an availability and/or response signal transmitted by the control station via the control mode transmission connection.

Additionally or alternatively, the construction machine control unit may comprise a decompression and/or compression module. This module may be configured to compress data to be transmitted to the control station control unit and/or to decompress compressed data received from the control station. Additionally or alternatively, an encryption and/or decryption module may also be provided for encrypting data to be transmitted to the construction machine and/or for decrypting encrypted data received from the control station.

The construction machine control unit may additionally or alternatively comprise an evaluation module, which may, for example, be configured such that it evaluates status data obtained from the construction machine, in particular from the sensor device, and checks for occurrence and/or absence of an activation event, for example. This may be done using event libraries included in the evaluation module and/or with the aid of a plausibility check, in which, for example, it is checked whether or not one or more available status data is plausible, for example within possible and/or, particularly relative to each other, reasonable ranges and/or within authorized limits.

Additionally or alternatively, the construction machine control unit may comprise an operating control module configured such that it controls a highly automated, particularly autonomous, control of traveling and/or steering and/or working functions of the construction machine. For this purpose, the operating control module may be configured in particular such that, depending on one or more status data, it automatically generates corresponding control commands for carrying out traveling and/or steering and/or working functions of the construction machine and transmits them within the construction machine for execution.

Additionally or alternatively, the construction machine control unit may comprise a switching module which controls and/or evaluates a switching over and/or switching in of the control mode transmission connection when an activation event has occurred and/or during a check for the presence of a control mode transmission connection. Additionally or alternatively, it is also possible, for example, for the switching module to be configured such that it deactivates and/or blocks the monitoring mode transmission connection when the control mode transmission connection is activated and/or controls and/or coordinates parallel operation of the two transmission connections. In particular, this may comprise assigning available status data of the construction machine to the control mode transmission connection and/or the monitoring mode transmission connection.

The construction machine control unit may also comprise an authorization check module, which may be configured such that it checks a communication of the construction machine with the control station, in particular the control station control unit, for one or more authorizations, for example with regard to an authorization of a control station itself and/or an operator of a control station. Additionally or alternatively, the authorization check module may check whether individual or several of the control data received from the control station or the associated control commands are authorized control data and/or control commands or not and, in the case of unauthorized control commands and/or control data, does not execute them and/or suppresses them and/or transmits a corresponding feedback to the control station, in particular via the control mode transmission connection and/or the monitoring mode transmission connection.

Additionally or alternatively, the construction machine control unit may comprise a documentation module, which is configured for at least partial and in particular complete documentation, in particular of the data exchanged with the control station and/or other construction machines, and for this purpose may for example comprise a suitable storage device or at least be connected to such a device. The documentation mode may additionally or alternatively also be configured to store internal construction machine data that has not been transmitted to and/or received by the control station and/or one or more other construction machines.

Finally, the construction machine control unit may additionally or alternatively also include an environment monitoring module. This module may, for example, be configured such that it uses status data to determine whether the construction machine with respect to itself and/or its surroundings can be operated safely and/or whether there is a danger to the construction machine itself and/or its surroundings due to the current status of the construction machine. Such dangers may be, for example, potential collision risks, the presence of one or more persons in the vicinity of the construction machine, etc. The environment monitoring module may include suitable image processing software, etc., in particular for obstacle and/or person identification.

It is additionally or alternatively advantageous if the at least one control station has a control station control unit. This may also be a computer device with one or more computer programs, which in particular are also configured to perform monitoring functions and/or tasks. The control station control unit may also be configured to control the transmission of control data in control mode via the control mode transmission connection.

For this purpose, the control station control unit may have one or more modules, in particular in the form of at least one or more computer programs.

For example, the control station control unit may be configured such that it comprises a check module. In particular, the check module may be configured such that it checks and/or monitors during operation of the construction machine whether the monitoring mode transmission connection is functional or whether status data is being received via this transmission connection and/or whether the control data transmission connection is available or not. This may be done, for example, such that a test transmission of an availability signal is carried out via the monitoring mode transmission connection or such an availability signal is transmitted at regular intervals by the construction machine independently of the transmission of further status data. Additionally or alternatively, the check module may also be configured to check the availability of the control mode transmission connection. For this purpose, the control station control unit may send an availability signal to the construction machine at regular intervals via the control mode transmission connection, thereby requesting a response signal and waiting for and checking the receipt of this response signal, whether via the control mode transmission connection and/or the monitoring mode transmission connection.

The control station control unit may comprise a decompression/compression module and/or an encryption/decryption module, in particular for compressing and/or encrypting data to be transmitted to the construction machine, in particular via the control mode transmission connection, and/or for decompressing and/or decrypting compressed and/or encrypted data received from the construction machine, in particular status data.

An evaluation module may also be part of the control station control unit. This module may be configured to check whether or not an activation event has occurred based on status data received from the construction machine via the monitoring mode transmission connection. This may be done solely based on status data and/or alternatively with further consideration of additional information and/or check parameters, such as a plausibility check. The plausibility check may comprise, for example, a check as to whether a development of status data and/or a relationship between status data is reasonable and realistic or not. To identify the occurrence of a trigger event, the control station control unit may comprise a database or library with trigger events defined by one or more limit values and/or ranges, etc.

The control station control unit may additionally or alternatively comprise an authorization check module. This module may be configured such that it checks a communication of the control station with the construction machine, in particular the construction machine control unit, for one or more authorizations, for example with regard to an authorization of a construction machine itself and/or an authorization of an operator of the control station.

The control station control unit may further comprise a documentation module configured for at least partial and in particular complete communication with the construction machine. It may be configured to store data, in particular status data, received from the construction machine and/or data relating to inputs from an operator of the control station and/or data, in particular control data, transmitted from the control station to the construction machine. For this purpose, the control station control unit may, for example, comprise, or at least be connected to, a suitable storage device.

Another additional or alternative module included in the control station control unit may be an environment monitoring module. This module may be configured to monitor the surroundings of the construction machine, in particular with regard to existing collision risks, etc., based on the status data received from the construction machine. In particular, the control station control unit may also take into account status data that it has received from construction machines other than the particular construction machine or from additional construction machines to the particular construction machine.

As mentioned above, the control mode transmission connection is a transmission connection with a comparatively low latency and/or a comparatively high data transmission rate compared to the monitoring mode transmission connection. Accordingly, it may be particularly preferred that the control mode transmission connection is, for example, an exclusive data transmission connection between the control station and the construction machine, such as can be booked in advance with one or more service providers. Additionally or alternatively, it may also be possible to book a preferred data transmission option with such a service provider. Both the control mode transmission connection and the monitoring mode transmission connection may be formed at least in sections as a wired, for example fiber optic, a wireless, for example via a local Wifi and/or 5G and/or satellite-based, or other suitable data transmission connection. It may also be possible, for example, for both the control mode transmission connection and the monitoring mode transmission connection to run at least partially along the same paths or along paths that are different from one another. Local transmission systems, such as Bluetooth, 5G campus networks, etc., may also be integrated.

The control station and the construction machine may be configured such that they exchange data bidirectionally via the control mode transmission connection in control mode. In this way, it is also possible, for example, for the system to be operated in control mode such that the control station and the construction machine communicate with each other exclusively via the control mode transmission connection and exchange data with each other for this purpose.

The monitoring mode transmission connection or the data transmission connection formed by it is preferably configured such that it is designed at least in sections as an underground cable-based, in particular fiber optic-based, data transmission connection. Such data transmission connections are comparatively robust and generally allow low-cost data transmission. This may also involve, for example, at least partial integration of a 2G or 3G mobile connection and/or LoRaWAN.

It is preferred if the system is configured such that in monitoring mode and/or in control mode, data is transmitted exclusively unidirectionally from the construction machine to the control station via the monitoring mode transmission connection. Especially for operation in control mode, this may mean that status data of the construction machine is also transmitted simultaneously from the construction machine to the control station via the monitoring mode transmission connection and the control mode transmission connection, but control data from the control station to the construction machine is only transmitted exclusively via the control mode transmission connection from the control station to the construction machine. The status data transmitted from the construction machine to the control station in control mode via the monitoring mode transmission connection may in particular be status data that usually changes comparatively slowly and/or is not safety-relevant. This may, for example, refer to machine-internal operating parameters, such as a fill level, etc., or machine-external operating parameters, such as climatic ambient conditions, etc. Additionally or alternatively, certain status parameters may be transmitted exclusively and always via the control mode transmission connection in control mode. This may, for example, concern security-relevant status information, such as status data for environmental monitoring, for example in the form of a video feed, etc. Additionally or alternatively, this may involve status data relating to traveling and/or working operation, for example a currently set travel mode, a steering mode, a vibration presetting, a steering control and/or sprinkler settings, setting values of one or more assistance systems, etc.

Generally, the control station control unit and/or the construction machine control unit may be configured in particular such that they comprise a processor, a memory and in each case at least one communication device, in particular with a signal input and with a signal output. The processor may be implemented in hardware, firmware and/or a combination of hardware and software that may be programmed to perform one or more of the foregoing functions. The memory may comprise random access memory (RAM), read only memory (ROM) and/or another type of dynamic or static storage device that stores information and/or instructions for execution by the processor. To establish the monitoring mode transmission connection and/or the control mode transmission connection, the construction machine and/or the control station may comprise one or more communication devices or transmitting and/or receiving devices, for example one or more antennas. These may be components for a local area network (LAN) (e.g. an Ethernet component), components for a wireless local area network (WLAN) (e.g. a Wi-Fi component), components for radio frequency communication (RF communication) (e.g. a Bluetooth® component), components for establishing a data transmission connection with a satellite communication system (e.g. Starlink, OneWeb), such as one or more suitable transmitting and/or receiving antennas, components of locally or globally used mobile radio networks, such as 5G campus networks and/or 5G mobile radio, etc. It is possible for one or more of the antennas to be controlled by several amplifiers. Specific antennas may be provided for each transmission medium, for example for Wifi 2.4GHz and 5GHz. It is possible that the one or more communication devices are configured and operated such that at least one antenna changes the frequency band and/or the transmission protocol on the software side for a respective data transmission. If, for example, a WLAN transmission is used, the same protocol and/or antenna may be used when switching between the monitoring mode transmission connection and the control mode transmission connection, but the frequency band may be changed, for example between 2.4GHz, 5GHz and 6GHz. When using mobile radio frequencies, it is possible to switch in the LTE standard (4G) from band 28 for the monitoring mode transmission connection to band 7 for the control mode transmission connection. In particular for the transmission of one or more control signals to the construction machine, a part of the control mode transmission connection may use a radio link.

### BRIEF DESCRIPTION OF THE DRAWINGS

The invention will be explained in more detail below by reference to the embodiment examples shown in the figures. In the schematic figures:

FIG. 1 is a view of a system for performing a work task of at least one highly automated, in particular autonomous, self-propelled construction machine from a control station located remotely from the construction machine in a monitoring mode;

FIG. 2 is a view of a system for performing a work task of at least one highly automated, in particular autonomous, self-propelled construction machine from a control station located remotely from the construction machine, at least partially in a control mode;

FIG. 3 is a view illustrating a possible structure of a construction machine;

FIG. 4 is a view illustrating a possible structure of a control station;

FIG. 5 is a flow chart of a method for operating a system for performing a work task of a highly automated, in particular autonomous, self-propelled construction machine from a control station located remotely from the construction machine;

FIG. 6 is a curve of the operation of a system in a monitoring mode and in a control mode;

FIG. 7A is a curve of a data transmission rate in monitoring mode via a monitoring mode transmission connection from a construction machine to a control station;

FIG. 7B is a curve of a data transmission rate in monitoring mode via the monitoring mode transmission connection of FIG. 7A from the control station to the construction machine;

FIG. 8A is a curve of a data transmission rate in control mode via a control mode transmission connection from a construction machine to a control station;

FIG. 8B is a curve of a data transmission rate in control mode via the control mode transmission connection of FIG. 8B from the control station to the construction machine;

FIG. 9 is a side view of a construction machine configured as a rubber-wheeled roller;

FIG. 10 is a side view of a construction machine configured as a waste compactor;

FIG. 11 is a side view of a construction machine configured as a single-drum roller;

FIG. 12 is a side view of a construction machine configured as a road paver; and

FIG. 13 is a side view of a construction machine configured as a ground milling machine.

### DETAILED DESCRIPTION

Like parts or functionally like parts are designated by like reference numerals in the figures. Recurring parts are not necessarily designated separately in each figure.

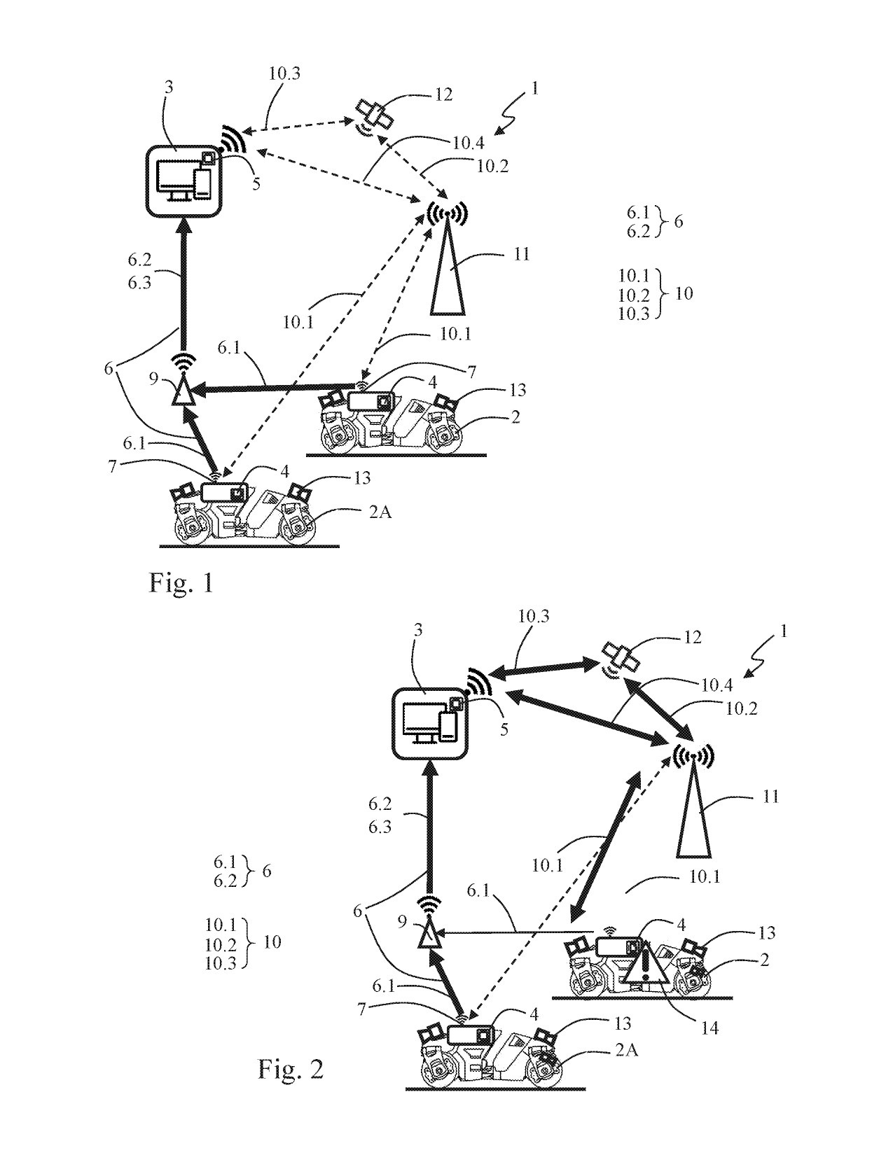

FIG. 1 shows a system 1, i.e., a system for performing a work task of at least one, in particular highly automated, in particular at least partially and in particular fully autonomous, self-propelled construction machine 2 from a control station 3 located remotely from the construction machine 2. The system 1 comprises at least one construction machine 2. It may have one or more further construction machines 2A etc., wherein only one further construction machine 2A is shown as an example in FIG. 1. A control station 3 is also part of the system 1.

The construction machine or machines 2, 2A etc. may be highly automated, in particular autonomous, self-propelled construction machines 2. Such construction machines 2 may each comprise a construction machine control unit 4, which may independently generate travel commands and/or other control data or control commands for a travel and/or working operation of the construction machine 2 during operation of the respective construction machine 1. Possible construction details of such a construction machine 2, 2A etc. are described in more detail in the figures below.

The control station 3 may be an operating station remote from the construction machine(s) 2, 2A etc. The control station 3 may therefore also be described as a teleoperation workstation with an operator or teleoperator. The control station 3 may be wherein it is not moved along with the construction machine 2 and the construction machine 2 is also not within sight of the control station 3, but in particular at a completely different location. The control station 3 may be several hundred or more kilometers away from the construction machine(s) 2, 2A, 2B, etc. The control station 3 may be immobile or stationary. From the control station 3, an operator or teleoperator may influence the operation of the one or more construction machines 2, 2A, etc., as shown further below by way of example. Possible construction details of such a control station 3 are described in more detail in the figures below.

According to FIG. 1, the system 1 may be configured such that each of the construction machines 2, 2A is in communication with the control station 3 via at least one monitoring mode transmission connection 6, i.e., can exchange data unidirectionally or bidirectionally with it. For example, the construction machines 2, 2A may each comprise a sending device 7. This device is configured to transmit status data of the respective construction machine 2, 2A. To transmit this status data, the monitoring mode transmission connection 6 between a signal output at the respective construction machine 2, 2A and a signal input at the control station 3 may comprise one or more transmission connection sections. These may be, for example, as in the embodiment example in FIG. 1, a first section 6.1, for example in the form of a local wireless network between the respective construction machine 2, 2A etc. and a construction site router 9, which is formed for example by a local wireless network, and/or a second section 6.2 between the construction site router 9 and the control station 3, which may be provided for example by an underground cable (illustratively, the underground cable section is designated with 6.3), in particular for example a fiber optic cable or the like. In the embodiment example shown in FIG. 1, the monitoring mode transmission connections 6 are unidirectional data transmission connections. However, it is also possible for them to be configured for bidirectional data transmission.

FIG. 1 further illustrates that, in addition to the monitoring mode transmission connection(s) 6, one or more control mode transmission connections 10 may also be provided. These may be data transmission connections that have a lower latency and/or a higher data transmission rate and/or a greater bandwidth compared to the monitoring mode transmission connection(s) 6 between the respective signal output at the respective construction machine 2, 2A and the respective signal input at the control station 3. Data transmission between one or more of the construction machines 2, 2A etc. and the control station 3 is thus possible via the control mode transmission connection 10 significantly faster and/or more extensively per time unit with regard to the data to be transmitted than via the one or more monitoring mode transmission connections 6. The transmission path between the respective construction machine 2, 2A and the control station 3 may likewise comprise one or more sections. In the present case, for example, a first section 10.1 is provided in the form of a wireless data transmission connection starting from a signal output at the construction machine 2, 2A to a local transceiver antenna 11, from there a second section 10.2 to a communication satellite 12 and a third section 10.3 from there to a signal input, in particular as part of a suitable receiver, at the control station. Sections 10.2 and 10.3 together therefore form a satellite-based data transmission connection. The control mode transmission connection may additionally or alternatively comprise a further section 10.4, for example in the form of an underground cable.

FIGS. 1 and 2 illustrate that the monitoring mode transmission connection 6 and the control mode transmission connection between the control station 3 and the one or more construction machines 2, 2A etc. follow different paths. These may therefore have a spatially different course with regard to the course of their specific transmission paths and/or differ from each other with regard to the components involved along the respective transmission paths.

In FIG. 1, the system 1 is in a monitoring mode. In particular, this may mean that status data obtained at the respective construction machine 2, 2A is transmitted, in particular exclusively, from the respective construction machine 2, 2A to the control station 3 via the monitoring mode transmission connections 6. In FIG. 1, this is illustrated by the fact that active transmission connections are shown with a solid arrow and non-active transmission connections (specifically, the transmission sections formed in particular exclusively by sections of the control mode transmission connection 10) are shown with a dashed arrow. The status data is acquired by the respective construction machines 2, 2A using a sensor device 13, which may comprise one or more suitable sensors, as explained in more detail below. In monitoring mode in particular, not all of the status data acquired by the sensor device 13 needs to be transmitted to the control station 3. FIG. 1 also illustrates that it is possible for several construction machines 2, 2A to be monitored centrally at the same time from a common control station 3.

The monitoring mode corresponds to an operating mode of the system 1 in which, for example, all movements and/or working functions performed by the construction machine 2, 2A function properly, for example as prescribed according to a predetermined work plan of the respective construction machine 2, 2A, and/or no potential risks are detected or identified in the environment of the respective construction machine 2, 2A. However, operational situations may occur in which one or more deviations occur in the operation of one or more of the construction machines 2, 2A, for example if one or more operating components of one of the construction machines 2, 2A is defective and/or consumable resources carried by the construction machine 2, 2A will soon be or are depleted, such as fuel, electrical energy and/or one or more operating fluids, and/or operational risks occur, for example in the vicinity of the respective construction machine 2, 2A, such as potential collisions, etc. If one or more of these risks are detected, this is also referred to below as an activation event, wherein the detection of the occurrence and/or presence of such an activation event may take place on the side of the construction machine 2, 2A, in particular by the construction machine control unit 4, and/or on the side of the control station 3, in particular by the construction machine control unit 5. In this context, it is also possible to prioritize individual activation events if several activation events occur at the same time or overlap in time. For example, a distinction may also be made between activation events to be addressed immediately and events to be addressed at a later time. If, for example, the construction machine 2 stops working and/or is stuck and/or similar, this may be an activation event to be addressed immediately with an immediate switchover to control mode. The situation may be different if, for example, only a future need for action is reported, such as when the level of one or more operating fluids falls below a threshold and needs to be replenished in the relatively near future.

In the event of the occurrence and detection of such a triggering or activation event, the system 1 may now switch at least partially from the monitoring mode to a control mode and, for this purpose, activates and carries out the communication of the control station 3 with one or more of the construction machines 2, 2A via the control mode transmission connection 10 in addition to or as an alternative to the monitoring mode transmission connection 6. In particular, this may be done bidirectionally between the respective construction machine 2, 2A and the control station 3.

FIG. 2 shows an example of this for the construction machine 2, which encounters an activation event 14 indicated by a symbol. FIG. 2 illustrates that the control mode transmission connection 10 between the construction machine 2 and the control station 3 is activated and data can be or is exchanged between the control station 3 and the construction machine 2. In particular, particularly extensive status data may be transmitted from the construction machine 2 to the control station 3 in virtually real time, for example in the form of an audio and/or video feed, and/or control data encoding one or more control commands may be transmitted from the control station 3 to the construction machine 2. It is possible that the construction machine 2 in control mode no longer communicates with the control station 3 at all via the monitoring mode transmission connection 6 and only exclusively via the control mode transmission connection 10 or, as shown as an example in FIG. 2, continues to simultaneously transmit status data to the control station 3 via the monitoring mode transmission connection 6. Since the control mode transmission connection 10 is faster than the monitoring mode transmission connection 6 in terms of latency and/or more powerful in terms of the data transmission rate or the amount of data transmitted/transmittable per unit of time and/or more comprehensive in terms of the available bandwidth, it is therefore possible to observe what is happening on site and/or issue control commands for execution on the construction machine 2 from the control station 3 virtually in real time or at least much closer to real time in the event of an activation event. However, since such high-performance data transmission connections are often only available to a limited extent and/or their use is comparatively expensive, it is advantageous to concentrate the use of the control mode transmission connection 10 on those operating phases of the system 1 that deviate from normal operation.

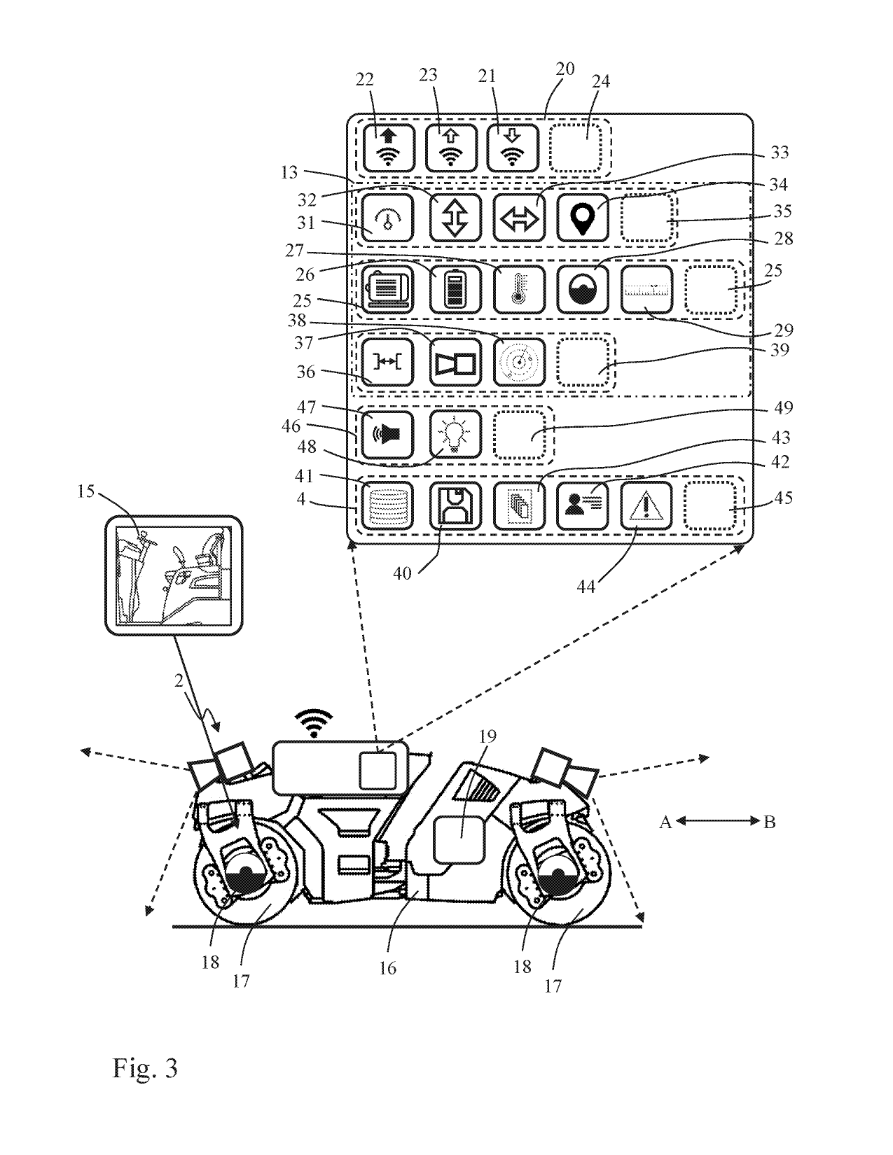

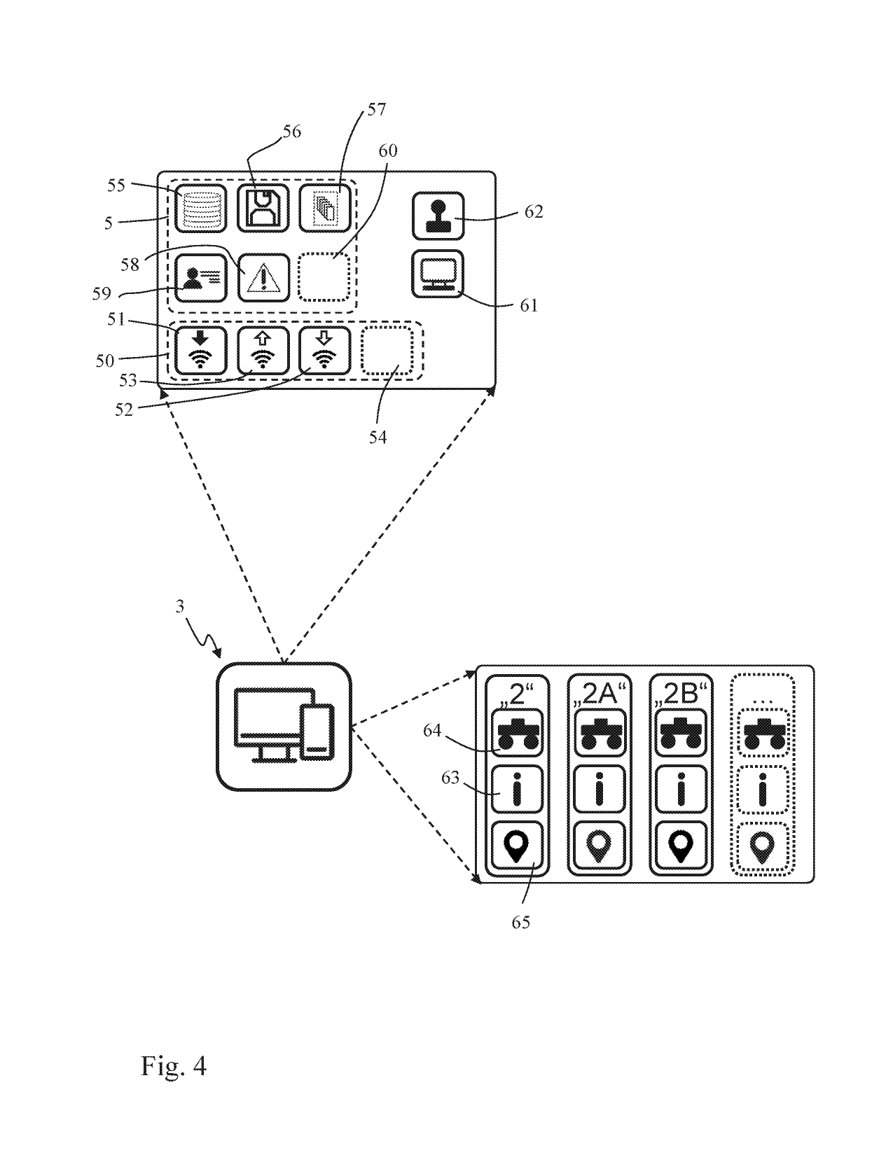

FIGS. 3 and 4 illustrate further possible details of the structure of the construction machine 2 etc. (FIG. 3) and the control station 4.

The construction machine 2 may be a self-propelled construction machine that performs both travel movements and working functions in a highly automated or even fully autonomous manner. It is also possible for the construction machine to be operated semi-autonomously and/or have an operator platform 15. However, it may also be configured without such an operator platform to accommodate at least one operator. In other words, it may also be configured such that it can be operated without the physical presence of a human operator, neither on the construction machine nor within sight of the construction machine, and based on control commands given autonomously by the construction machine.

According to FIG. 3, the construction machine 2 may comprise a machine frame 16, which may in particular form the essential support structure of the construction machine 2. The machine frame may be carried by one or more travel units 17, which may be roller drums, wheels and/or crawler tracks, for example. The construction machine 2 may further comprise one or more working units 18 configured to perform one or more working functions. In the construction machine 2 shown in FIG. 3, which is illustratively configured as a ground compaction machine of the tandem roller type, the working units 18 may, for example, be vibration excitation devices or so-called imbalance exciters associated with the travel units, which are configured as roller drums. To provide the drive energy required for traveling and working operation of the construction machine 2, the construction machine 2 may have one or more drive motors 19, for example in the form of one or more combustion engines and/or electric motors, etc. It is possible for the construction machine 2 to move in the forward direction A and/or in the reverse direction B during traveling and working operation.

The construction machine 2 may comprise a sending and/or receiving device 20. This device may comprise a signal output 22 for sending status data from the construction machine 2 and transmitting it to the control station 3 via the monitoring mode transmission connection 6. It can comprise a further signal output 23 for sending status data from the construction machine 2 and transmitting it to the control station 3 via the control mode transmission connection 10. Additionally or alternatively, the sending and/or receiving device 20 may further comprise a signal input 21, in particular for receiving control data transmitted from the control station 3 to the construction machine 2 via the control mode transmission connection 10. It will be appreciated that the individual signal outputs 22 and 23 and/or the signal input(s) 21 may be configured separately or combined with each other. Further signal inputs and/or outputs 24 may also be included by the sending and/or receiving device 20.

The construction machine 2 may further comprise a sensor device 13 with a large number of sensors, via which status data of the construction machine 2 can be determined and transmitted, at least in part, to the control station 3. For this purpose, the sensor device 13 may, for example, comprise one or more suitable sensors, such as one or more engine sensors 25 and/or state of charge sensors 26 and/or filling level sensors 27 and/or acceleration sensors 28 and/or displacement and/or position sensors 29 and/or other sensors, such as sensors for detecting an activation state of one or more activatable devices of the construction machine, for detecting one or more force loads and/or torques, sensors for detecting one or more operating temperatures, etc., in order to determine internal machine status data. The sensor device 13 may additionally or alternatively also have one or more sensors for acquiring status data relating to a movement behavior of the construction machine 2 in a terrain. These may be, for example, one or more travel speed sensors 31, direction of travel sensors 32, steering sensors 33, inclination sensors, position sensors 34 (in particular in the form of one or more GNSS sensors and/or receiving sensors of a local reference system, for example by means of one or more total stations) and/or other sensors 35. Additionally or alternatively, the sensor device 13 may also be configured to detect external status data of the construction machine 2 and, for example, have one or more distance sensors 36, for example ultrasonic sensors, and/or one or more cameras 37, in particular video cameras, one or more LIDAR sensors 38 and/or other sensors 39 for detecting the current external environment of the construction machine 2. These may also be, for example, one or more sensors for detecting climatic conditions, such as an outside temperature and/or an outside humidity, for detecting a surface temperature, etc.

The construction machine control unit 4 may also comprise one or more modules, in particular in the form of one or more computer programs, in particular for carrying out highly automated, in particular autonomous, traveling and/or working functions and/or for checking the communication with the control station 3 and/or for checking the status data determined on the construction machine 2. Such modules may, for example, be an operating control module 40, which is used in particular to control the traveling and/or working functions of the construction machine 2. Additionally or alternatively, a documentation module 41 may be included, via which status and/or operating data of the construction machine 2 can be stored in a suitable storage device, and/or an authorization check module 42, which is used to check for authorized communication with the control station 3 and/or an operator operating the control station 3 and/or the construction machine 2 on site and/or to check for authorized control commands. Additionally or alternatively, such a module may be an evaluation module 43 configured in particular for at least partial evaluation of the acquired status data of the construction machine 2, and/or a check module 44 configured to check whether an activation event has currently occurred and/or a control mode transmission connection and/or monitoring mode transmission connection is available. Furthermore, one or more further modules 45, for example a switching and/or coordination module to coordinate the data exchange via the control mode transmission connection and/or the monitoring mode transmission connection with the control station and/or one or more further construction machines 2A, an environment monitoring module to monitor the environment of the construction machine 2, in particular during operation, for operating risks, such as hazardous operating situations (for example persons located in the vicinity of the construction machine 2), imminent collisions with, for example, static and/or moving obstacles, etc., may also be provided separately or in addition. Additionally or alternatively, the construction machine 2 may also comprise a decompression and/or compression module and/or an encryption and/or decryption module, for example.

Finally, part of the construction machine 1 may also be a display and/or signaling device 46, for example comprising one or more loudspeakers and/or microphones 47 and/or visually perceptible display devices 48, such as indicator lights, displays, etc., and/or other display devices.

According to FIG. 4, the control station 3 may comprise a sending and/or receiving device 50. This device may have a signal input 51 for receiving status data of the construction machine 2 transmitted via the monitoring mode transmission connection. A signal input 52 and a signal output 53 may be provided for communication via the control mode transmission connection. Additionally or alternatively, further signal inputs and/or outputs may be included by the sending and/or receiving device 50.

The control station control unit 5 may also comprise one or more modules, in particular in the form of one or more computer programs. These may be, for example, a documentation module 55, an operating control module 56, an evaluation module 57, a check module 58, an authorization check module 59 and/or one or more further modules, such as a compression and/or decompression module for compressing/decompressing data to be sent and/or received and/or an encryption and/or decryption module for encrypting/decrypting data to be sent and/or received. With regard to the individual functions that can be performed by these modules, reference is made to the above information.

The control station 3 may also include one or more display and/or signaling devices 61, such as one or more display screens and/or one or more VR goggles, etc., and/or one or more input devices 62, such as a keyboard, one or more control levers, etc.

The control station 3 may be configured for simultaneous communication with the at least one construction machine 2 and other construction machines 2A, etc. For this purpose, each of the construction machines 2, 2A currently monitored by the control station 3 may be individually monitored by the control station 3 and each of the construction machines 2, 2A may thus be assigned individual data, for example its own status data 63, machine configuration data 64 and/or position data 65. In this respect, the control station 3 may, for example, also be configured such that it checks for each of the construction machines 2, 2A etc. independently of each other whether an activation event has occurred or not, and/or communicates with one or more of these construction machines 2, 2A etc. individually and selectively via the control mode transmission connection as required.

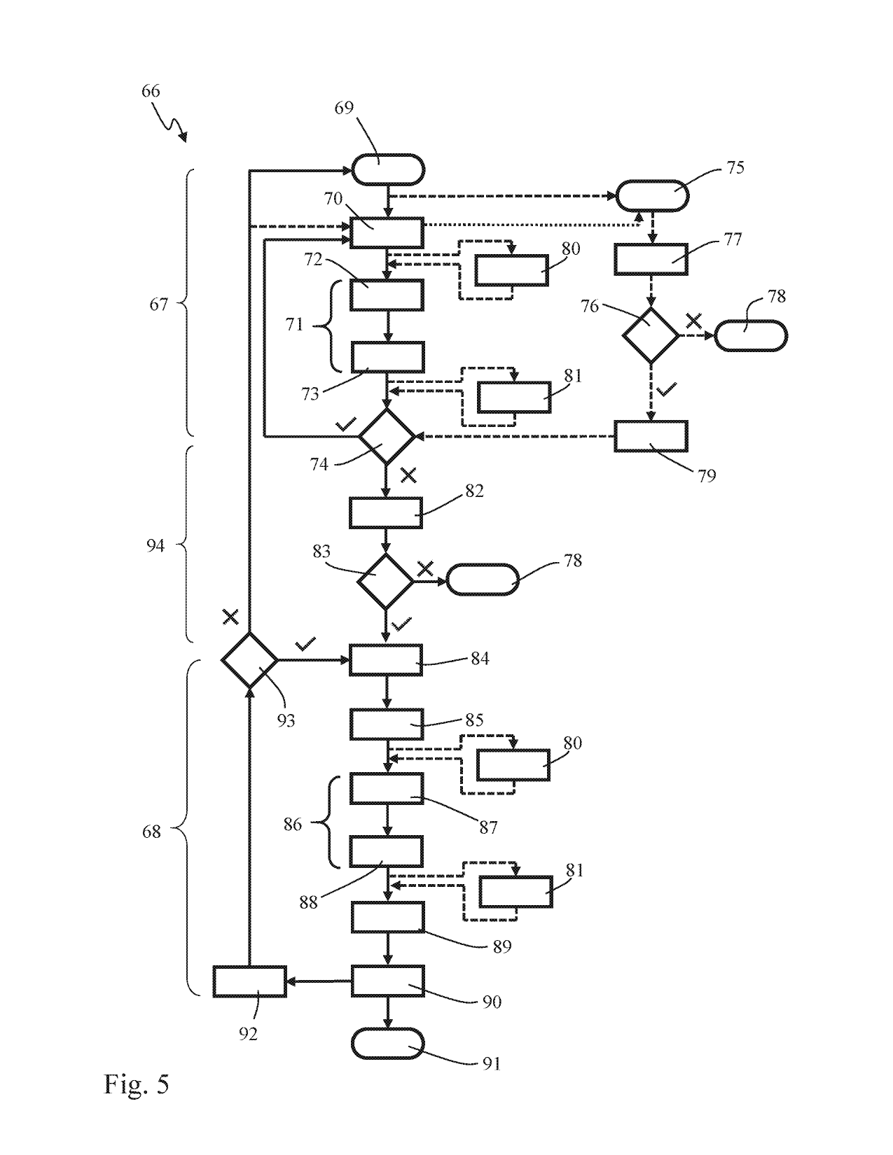

FIG. 5 illustrates possible steps of an exemplary method 66 for operating a system 1 for performing a work task of a, in particular highly automated, especially autonomous, self-propelled construction machine from a control station located remotely from the construction machine. With regard to possible configurations and embodiments of the individual components involved in the method, such as in particular the control station 3 and the one or more construction machines 2, 2A, reference is made in particular to the preceding information. The method 66 may be roughly divided into two operating phases, specifically an operation 67 in a monitoring mode and an operation 68 in a control mode. In particular, when monitoring several construction machines using a shared control station as described above, it may also be possible for the control station to communicate simultaneously with one or more construction machines in monitoring mode and with one or more other construction machines in control mode.

The monitoring mode, a step 69 may initially comprise starting operation of the one or more construction machines 2, 2A. This may be done, for example, by starting the construction machine 2, 2A or a similar initialization process. For example, it may also be possible to start this step from the control station 3. The monitoring mode transmission connection and/or the control mode transmission connection may be used for the corresponding signal transmission from the control station 3 to the one or more construction machines 2, 2A. It is possible that in this case the construction machine 2, 2A transmits a reception or confirmation signal to the control station 3 in response to a reception of a corresponding signal from the control station 3. This may be done via the monitoring mode transmission connection and/or the control mode transmission connection, wherein it is preferred that the communication between the control station and the construction machine or machines 2, 2A in this case takes place such that one of the two transmission connections is used to transmit the signal or signals from the control station to the construction machine and the other transmission connection is used to transmit the signal or signals from the one or more construction machines to the control station. In this way, it is possible to check simultaneously at the start of the method whether both the monitoring mode transmission connection and the control mode transmission connection are available and functional. The method 66 may initially always start in monitoring mode or control mode when starting operation in this way.

A step 70 may comprise determining, in particular current, status data by the respective construction machine 2, 2A, in particular, for example, by a sensor device as described above. This may mean, for example, the recording of internal machine status data and/or external status data, such as the environment of the construction machine 2, 2A. The recorded status data may be processed by the construction machine control unit 4, for example checked to determine whether individual or several components of the construction machine 2, 2A are activated, deactivated and/or functional, and/or transmitted at least partially separately and/or as a result of such a check to the control station 3, in particular via the monitoring mode transmission connection. Transmitting 71 may thus comprise sending 72 status data per se and/or results of checks carried out based on status data at the construction machine 1 by, in particular, the construction machine control unit, in particular by means of a suitable sending and/or receiving device, and receiving 73 this status data and/or results of tests carried out at the control station 3, in particular by means of a suitable sending and/or receiving device. It is noted here for precaution that, for the purposes of the present disclosure, a transmission of status data may also comprise, additionally or alternatively, a transmission of results of checks based on status data.

Based on the data determined on the construction machine 2, 2A and/or the data transmitted to the control station 3, in particular status data, a step 74 may now comprise checking as to whether the system 1 as a whole and/or the construction machine 2, 2A and/or the control station 3 and/or the monitoring mode transmission connection and/or the control mode transmission connection are functioning properly and/or are in a permissible operating state. In other words, a check may be carried out to determine whether or not there is currently an activation event. This may include a check for the occurrence of, for example, process-dependent and/or safety-dependent and/or service-dependent activation events. If this is not the case (i.e., if there is no activation event), step 70 may again be initialized during operation of the system in monitoring mode and a checking and monitoring loop is obtained in this way. However, if an activation event occurs, it may be possible to switch to control mode, as explained in more detail below. Checking for occurrence and/or absence of an activation event may be carried out by the construction machine control unit 4 and/or the control station control unit 5 and/or, for example, by a teleoperator manually at the control station 3.

Upon, or triggered by, starting 69 operation, the method may comprise, in particular in parallel or simultaneously with steps 70 et seq., querying/verifying 75 to determine whether the monitoring mode transmission connection and/or the control mode transmission connection are available and functional. For this purpose, a check 76 can be carried out, for example by transmitting 77 a test signal via the respective transmission connection. This can be done unidirectionally or bidirectionally on the respective transmission connection between the control station and the respective construction machine 2, 2A. Evaluation variables for such a check may be, for example, a current latency and/or a current data transmission rate of the respective transmission connection. If the check leads to the result that the monitoring mode transmission connection and/or the control mode transmission connection is not available and/or not functional, the operation of the construction machine 2, 2A may be stopped, for example by stopping a travel movement and/or deactivating an activation state of the construction machine 2, 2A. On the other hand, if the check 76 leads to the result that the monitoring mode transmission connection and/or the control mode transmission connection is available and/or functional, operation in monitoring mode may be allowed 79. Steps 75 to 79 may additionally or alternatively also be initialized by, or be carried out as part of, step 70, and may also be carried out in the form of a monitoring loop.

Prior to transmitting 72, compressing and/or encrypting 81 of the status data to be transmitted to the control station via the monitoring mode transmission connection may be performed by the construction machine 2, 2A, in particular using the construction machine control unit 4. Accordingly, it is possible for the control station 3 to decompress and/or decrypt 82 the status data obtained or received via the monitoring mode transmission connection at the control station, in particular by the control station control unit 5.

In the event that it is determined in step 74, for example by the construction machine control unit 4 and/or the control station control unit 5, that the system 1 or parts thereof are not functioning properly and/or are not in a permissible operating state or an activation event has occurred, this may trigger establishing 82 of a signal transmission connection between the construction machine 2, 2A and the control station 3 via the control mode transmission connection 10. This may be initialized by the construction machine control unit 4 and/or the control station control unit 5. A check 83 may then be carried out, for example by the construction machine control unit and/or the control station control unit, as to whether or not the control mode transmission connection could/can or cannot be established. If the check leads 83 to the result that the control mode transmission connection is not available and/or not functional, the operation of the construction machine 2, 2A may be stopped, for example by stopping a travel movement and/or deactivating an activation state of the construction machine 2, 2A. If, on the other hand, the check 83 leads to the result that the control mode transmission connection could be established, a step 84 may comprise activating the control mode or starting operation in the control mode. This may be carried out by the construction machine control unit 4 and/or the control station control unit 5. It is also possible that, in response to step 84 or as part thereof, an operating mode status is switched or changed at the construction machine control unit 4 and/or the control station control unit 5 to an operation in control mode. Additionally or alternatively, the activation of the control mode may be exchanged between the construction machine 2, 2A and the control station 3 in one or both directions. The construction machines 2A may further be informed via the particular construction machine 2 and the control station 3 by transmission of one or more suitable signals that the particular construction machine 2 is now communicating with the control station 3 in control mode. Such transmission may take place directly between the particular construction machine 2 and the at least one other construction machine 2A or, for example, via and/or through the control station 3.

If the control mode is activated according to step 84, one or more control commands may be generated at the control station in a step 85, for example by the control station control unit 5 and/or by manual input from an operator working at the control station. For this purpose, the control station may have one or more suitable input means, such as a keyboard, etc. These control commands may then be transmitted, in particular in the form of control data, via the control mode transmission connection in step 86 from the control station 3 to the construction machine 2, 2A, which may comprise sending 87 the one or more control commands, in particular in the form of control data, via a signal output at the control station and/or receiving 88 the one or more control commands at a signal input of the construction machine 2, 2A. Again, this control data may be compressed and/or encrypted at the control station 3, in particular by the control station control unit 5, in a step 80, and decompressed and/or decrypted at the construction machine 2, 2A, in particular by the construction machine control unit 4, in a step 81.

A step 89 may now comprise executing the one or more control commands transmitted from the control station 3 to the construction machine 2, 2A via the control mode transmission connection at the construction machine. This may involve one or more steps, although not shown separately in FIG. 5. Similarly, it is possible that status data, for example in step 89, is still acquired at the construction machine as part of the control mode and transmitted to the control station via the control mode transmission connection and/or the monitoring mode transmission connection.

The control mode may be terminated in a step 90, for example if the cause of an activation event has been eliminated and/or is no longer present. This may be done in particular on the control station side, especially by a corresponding input from a teleoperator at the control station. Said terminating 90 may take place such that the operation of the system 1 or at least of the construction machine 2, 2A ends, for example by assuming 91 a deactivated state, comprising switching off an engine and/or assuming a parking and/or transport position, etc. This may end the method 66 per se. However, said terminating 90 of operation in control mode may also comprise allowing 92 a renewed transition to monitoring mode, which may then be followed by checking 93 as to whether the and/or any activation event is still present or not. If so, operation in the control mode is continued or resumed. Otherwise, the method 66 may be continued in monitoring mode in steps 60 or 70.

It will be appreciated that communication during operation 67 in monitoring mode between the construction machine 2, 2A and the control station 3 may preferably take place exclusively via the monitoring mode transmission connection, in particular exclusively unidirectionally from the construction machine 2, 2A to the control station 3. For operation 68 in control mode, it is possible that in this case at least the communication to the construction machine 2, 2A, for which the occurrence of an activation event has been determined, also takes place exclusively via the control mode transmission connection, in particular bidirectionally between the control station 3 and the corresponding construction machine 2, 2A. In addition to this, communication between the corresponding construction machine 2, 2A and the control station 3 may also take place simultaneously via the monitoring mode transmission connection and/or the control station 3 may continue to communicate with one or more other construction machines, in particular exclusively, via the monitoring mode transmission connection, in particular status data from this or these construction machines may be transmitted. Thus, starting from an operation 67 in monitoring mode and a communication via the monitoring mode transmission connection, switching 94 and/or adding a communication via the control mode transmission connection may be performed if an activation event has occurred and/or been detected during operation of one or more of the construction machines 2, 2A, preferably by the construction machine control unit 4 and/or the control station control unit 5.

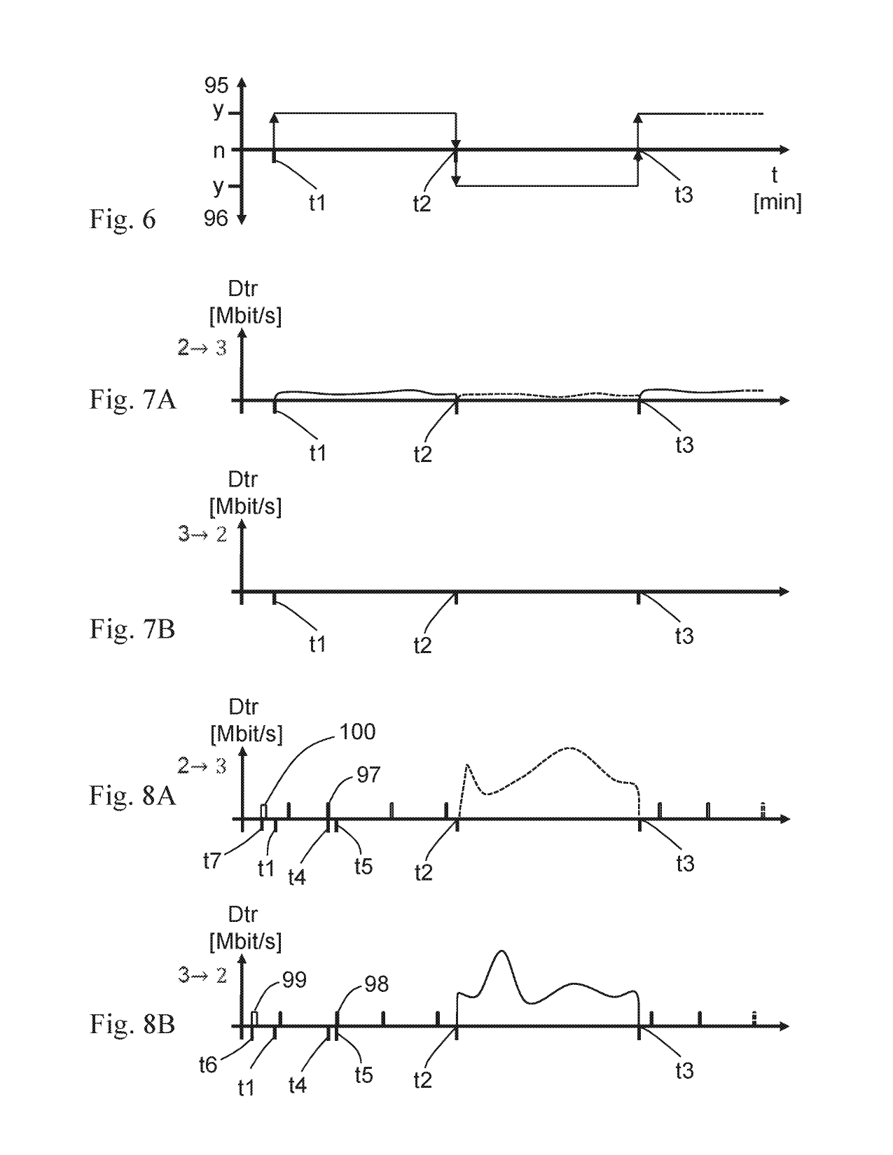

FIGS. 6, 7A, 7B, 8A and 8B illustrate a possible sequence, in particular underlying the method 66, by means of further diagrams.

FIG. 6 indicates whether the system 1 is currently in the monitoring mode 95 or in the control mode 96 with regard to communication with a construction machine 2. In the period t1 to t2 and from t3 onwards, operation in the present embodiment example thus takes place in monitoring mode 95 and not in control mode 96, and in the period t2 to t3 in control mode 96 and not in monitoring mode 95. An activation event is thus detected at time t2 and a return to monitoring mode 95 takes place at time t3.

FIGS. 7A and 7B show the current data transmission rate between the construction machine 2 and the control station 3 via the monitoring mode transmission connection, with FIG. 7A illustrating the data transmission from the construction machine 2 to the control station 3 and FIG. 7B illustrating the data transmission from the control station 3 to the construction machine 2. FIGS. 7A and 7B illustrate accordingly that in the present embodiment example, the monitoring mode transmission connection is configured as a unidirectional data transmission connection from the construction machine 2 to the control station 3 (FIG. 7A), as no data is transmitted in the opposite direction from the control station 3 either in monitoring mode or in control mode (FIG. 7B). However, it is also possible for the monitoring mode transmission connection to be exchanged as a bidirectional communication connection. FIGS. 7A and 7B illustrate that the volume of data to be transmitted over the monitoring mode transmission connection is relatively small, both in monitoring mode and in control mode.

FIGS. 7A and 7B further illustrate that for operation in control mode (t2 to t3), it is possible that no more data is exchanged at all via the monitoring mode transmission connection between the construction machine 2 and the control station 3 or, as indicated in FIG. 7A by the dashed line in this time range, data may continue to be transmitted, in particular exclusively from the construction machine 2 to the control station 3.

FIGS. 8A and 8B show that the data volume to be transmitted in control mode, in particular from the control station 3 to the construction machine 2 (FIG. 8B), may be comparatively large and therefore a relatively high data transmission rate is required. Additionally or alternatively, it is further possible that a comparatively large volume of data is to be transmitted from the construction machine 2 to the control station 3 (FIG. 8A), for example due to a desired video transmission etc. for the control mode. In order for the construction machine 2 to be operated in control mode from the control station 3 in near real time and/or, for example, the surroundings of the construction machine 2 to be viewed from the control station 3 in near real time, it is advantageous if the control mode transmission connection has or enables a lower latency and/or a higher data transmission rate compared to the monitoring mode transmission connection.

FIGS. 8A and 8B in particular further illustrate that during operation in monitoring mode, for example, an availability check may be run to determine whether or not the control mode transmission connection that is unused in this phase for transmitting status data, even if practically unused, is basically available and functional. For example, availability signals 97 and 98 may be exchanged at regular intervals between the construction machine 2 and the control station 3 via the control mode transmission connection. Specifically, for example, the first availability signal 97 may be sent from the construction machine 2 to the control station 3 at time t4 and the latter may respond with the availability signal 98 at time t5. Additionally or alternatively, such availability signals 97, 98 may also be exchanged independently at defined intervals between the construction machine 2 and the control station in a unidirectional or bidirectional manner. Additional evaluation variables for such an availability check may further be, for example, a current latency and/or a current data transmission rate of the respective transmission connection.

Additionally or alternatively, it is further possible that an availability and/or integrity check of the control mode transmission connection is carried out before activation of the monitoring mode, as indicated in FIGS. 8A and 8B, for example with the availability signals 99 and 100 at times t6 and t7. This may also be done in the same way for the monitoring mode transmission connection.

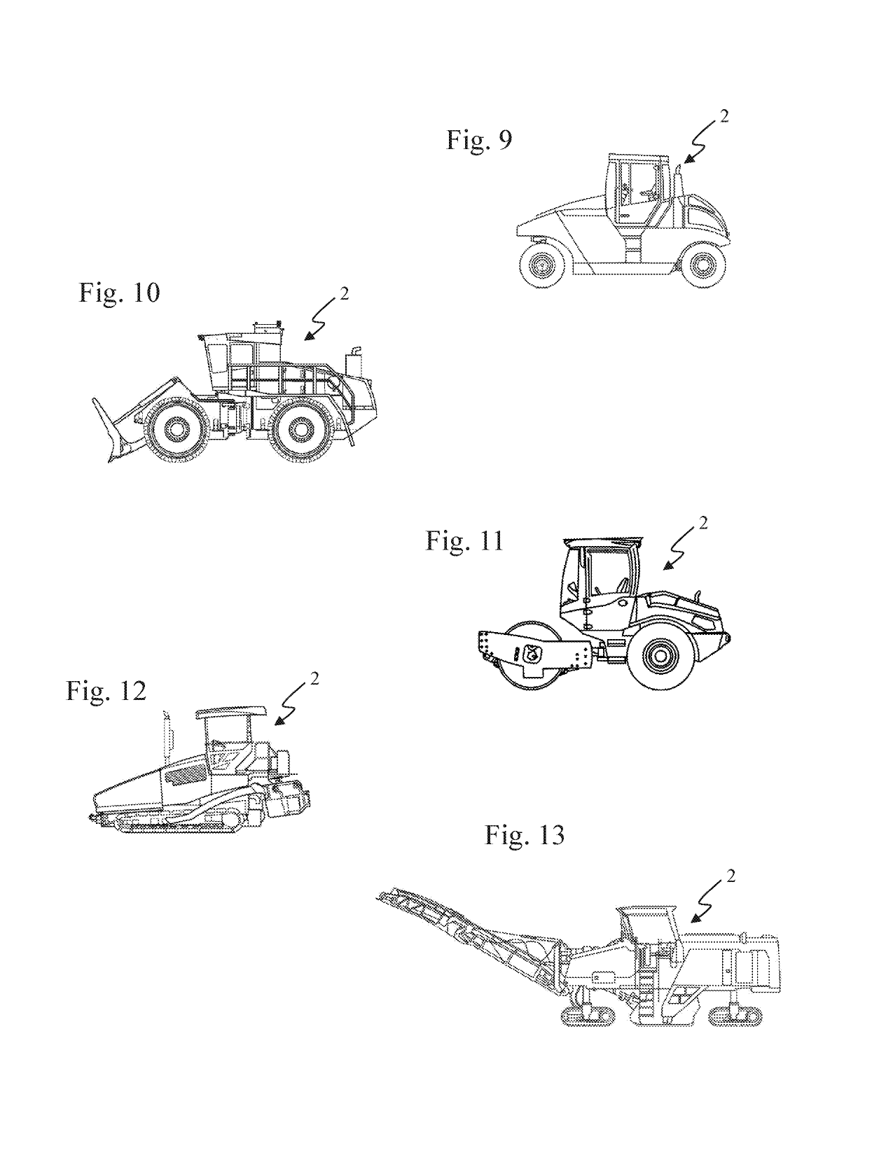

The construction machines 2 and 2A shown as examples in FIG. 1 are ground compaction machines, in particular tandem rollers. FIGS. 9-13 illustrate further types of construction machines, in particular road construction machines, which are particularly suitable for use in the above-described method 66 and/or as a component of the above-described system 1. FIG. 9 shows a construction machine 2 configured as a rubber-wheeled roller, FIG. 10 shows a construction machine 2 configured as a waste compactor, FIG. 11 shows a construction machine 2 configured as a single-drum roller, FIG. 12 shows a construction machine 2 configured as a road paver, and FIG. 13 shows a construction machine configured as a ground milling machine, in particular a road milling machine. Within the scope of the present description, all of these construction machines 2 may be configured as highly automated, particularly autonomous, self-propelled and, in particular, also highly automated, particularly autonomously operating construction machines 2 and comprise a construction machine control unit 4 and the other devices described above for the construction machine 2.

### LIST OF REFERENCE NUMERALS

A forward direction
B reverse direction
1 system
2 self-propelled construction machine
2A other construction machine
3 control station
4 construction machine control unit
5 control station control unit
6 monitoring mode transmission connection
6.1 first section
6.2 second section
6.3 further section (underground cable)
7 sending device
9 construction site router
10 control mode transmission connection
10.1 first section
10.2 second section
10.3 third section
10.4 further section (underground cable)
11 local transceiver antenna
12 communication satellite
13 sensor device
14 activation event
15 operator platform
16 machine frame
17 travel units
18 working unit
19 drive motor
20 construction machine side sending/receiving device
21 signal input at the at least one construction machine
22 signal output at the at least one construction machine
23 signal output at the at least one construction machine
24 further signal inputs and/or outputs
25 motor sensor
26 state of charge sensor
27 fill level sensor
28 acceleration sensor
29 displacement and/or position sensor
30 additional sensor
31 travel speed sensor
32 direction of travel sensor
33 steering sensor
34 position sensor
35 additional sensor
36 distance sensor
37 camera
38 LIDAR sensor
39 other sensors
40 operating control module
41 documentation module
42 authorization check module
43 evaluation module
44 check module
45 further module
46 display and signaling device
47 loudspeaker and/or microphone
48 visually perceptible display device
49 further display device
50 construction machine side sending/receiving device
51 signal input at control station
52 signal input at control station
53 signal output at control station
54 further signal inputs and/or outputs
55 documentation module
56 operating control module
57 evaluation module
58 check module
59 authorization check module
60 further module
61 display and signaling device
62 input device
63 status data
64 machine configuration data
65 position data
66 method for operating a system for performing a work task of a, in particular highly automated, especially autonomous, self-propelled construction machine from a control station located remotely from the construction machine
67 operation in monitoring mode
68 operation in control mode
69 start operation in monitoring mode
70 determine status data
71 transmit
72 send
73 receive
74 check
75 query
76 check
77 transmit
78 stop
79 allow
80 compress/encrypt
81 decompress/decrypt
82 establish a connection via control mode transmission connection
83 check
84 activate control mode
85 generate control commands
86 transmit
87 send
88 receive
89 execute
90 terminate
91 assume deactivated state
92 allow transition to monitoring mode
93 check
94 switch
95 monitoring mode
96 control mode
97 availability signal
98 availability signal
99 availability signal
100 availability signal

What is claimed is:

1. A method for operating a system for performing a work task of a self-propelled construction machine from a control station located remotely from the construction machine, comprising the steps of:
a) during a monitoring mode:
acquiring status data relating to the construction machine at the construction machine using a sensor device;
transmitting the acquired status data from the construction machine to the control station via a monitoring mode transmission connection;
b) during a control mode:
acquiring status data relating to the construction machine at the construction machine using the sensor device;
transmitting the acquired status data from the construction machine to the control station via a control mode transmission connection;
generating control data at the control station;
transmitting the control data from the control station to the construction machine via the control mode transmission connection;
wherein the control mode transmission connection has a lower latency and/or a higher data transmission rate and/or greater bandwidth compared to the monitoring mode transmission connection.

2. The method according to claim 1, wherein during operation of the construction machine in monitoring mode, the control mode transmission connection is unused but is kept available.

3. The method according to claim 1, wherein during operation of the construction machine in monitoring mode, an availability signal is exchanged at regular intervals between the construction machine and the control station via the control mode transmission connection.

4. The method according to claim 1, wherein in step a) status data to be transmitted from the construction machine to the control station is compressed on the construction machine side and decompressed on the control station side.

5. The method according to claim 1, wherein step a) comprises evaluating the status data as to whether or not an activation event has occurred, and in that, if an activation event has occurred, the control mode transmission connection is activated for data transmission at least from the control station to the construction machine.

6. The method according to claim 1, wherein the control mode transmission connection is activated depending on a process-dependent or safety-dependent or service-dependent activation event.

7. The method according to claim 1, wherein evaluating the status data as to whether an activation event has occurred is performed on the construction machine side and/or on the control station side.

8. The method according to claim 1, wherein during operation of the construction machine in control mode according to step b), autonomous control commands generated on the construction machine side are suppressed or at least executed with lower priority than control data received from the control station via the control mode transmission connection.

9. The method according to claim 1, wherein in step b) at least control data to be transmitted from the control station to the construction machine via the control mode transmission connection is encrypted on the control station side and encrypted control data received via the control mode transmission connection is decrypted on the construction machine side.

10. The method according to claim 1, wherein control data transmitted from the control station to the construction machine in step b) comprise a proof of authorization.

11. The method according to claim 1, wherein at least in step b), the control data and/or status data transmitted via the control mode transmission connection is transmitted at least partially via a satellite-based data transmission connection and/or via an underground cable-based data transmission connection between the control station and the construction machine.

12. The method according to claim 1, wherein during an activated control mode transmission connection, data, in particular at least some of the status data of the construction machine, is transmitted in parallel via the monitoring mode transmission connection.

13. The method according to claim 1, wherein in monitoring mode according to step a), a plurality of construction machines transmit status data to the particular control station in parallel in the monitoring mode and, when the control mode is activated, one of the plurality of construction machines is operated according to step b) while the other ones of the plurality of construction machines continue to be operated in the monitoring mode according to step a).

14. The method according to claim 1, wherein when the control mode of the particular one of the plurality of construction machines is activated according to step b), a status message is transmitted to the other ones of the plurality of construction machines, which are then, with respect to at least one operating parameter, operated to a limited extent in a protective operating mode compared with a normal operating mode.

15. The method according to claim 1, wherein when the control mode of the particular one of the plurality of construction machines is activated according to step b), further ones of the plurality of construction machines are stopped and/or switched off, at least until the particular one of the plurality of construction machines has returned to monitoring mode and/or has reached a defined parking position and/or an active permission has been given via the control station.

16. The method according to claim 1, wherein if the connection in step b) cannot be established by the particular construction machine of the plurality of construction machines, the particular construction machine establishes a signal transmission connection to one of the plurality of other construction machines and uses this as an intermediate connection to establish the control mode transmission connection.

17. A system for performing a work task of at least one self-propelled construction machine from a control station located remotely from the construction machine, in particular for carrying out a method according to claim 1, comprising:
at least one self-propelled construction machine, the construction machine having a sensor device for acquiring status data of the construction machine during operation of the construction machine;
a control station located remotely from the construction machine for monitoring operation of the at least one construction machine;
a monitoring mode transmission connection, via which status data of the construction machine acquired by the sensor device is transmitted to the control station during operation of the at least one construction machine,
wherein it comprises a control mode transmission connection configured for transmitting control data from the control station to the at least one construction machine, the control mode transmission connection having a lower latency and/or a higher data transmission rate and/or a greater bandwidth than the monitoring mode transmission connection.

18. The system according to claim 17, wherein the control mode transmission connection is configured such that its latency between a signal output/input at the control station and a signal input/output at the at least one construction machine is not more than 500 ms, in particular not more than 250 ms, especially not more than 50 ms and ideally not more than 10 ms.

19. The system according to claim 17, wherein the control mode transmission connection is configured such that its data transmission rate between a signal output/input at the control station and a signal input/output at the at least one construction machine is at least 1 s, in particular at least 2 s.

20. The system according to claim 17, wherein the at least one construction machine has a construction machine control unit, the construction machine control unit having at least one of the following modules:
a check module;
a decompression/compression module;
an encryption/decryption module;
an evaluation module;
an operating control module;
a switching module;
an authorization check module;
a documentation module;
an environment monitoring module.

21. The system according to claim 17, wherein the at least one control station has a control station control unit, the control station control unit having at least one of the following modules:
a check module;
a decompression/compression module;
an encryption/decryption module;
an evaluation module;
an operating control module;
an authorization check module;
a documentation module.

22. The system according to claim 17, wherein the control mode transmission connection is configured at least in sections as a satellite-based data transmission connection and/or as an underground cable-based data transmission connection.

23. The system according to claim 17, wherein the control station and the construction machine are configured such that they exchange data bidirectionally via the control mode transmission connection in control mode.

24. The system according to claim 17, wherein the monitoring mode transmission connection is configured at least in sections as a fiber-optic and/or satellite-based data transmission connection.

25. The system according to claim 17, wherein the control station and the construction machine are configured such that in control mode they transmit data from the construction machine to the control station exclusively unidirectionally via the monitoring mode transmission connection.
